(19) United States
(12) Patent Application Publication
(10) Pub. No.: US 2018/0189328 A1
(43) Pub. Date: Jul. 5, 2018

(54) METHOD AND SYSTEM FOR PROVIDING DATA ACCESS AND LOCAL PROCESSING ACROSS DISPARATE DATA SYSTEMS

(71) Applicant: Teradata US, Inc., Dayton, OH (US)

(72) Inventors: John Douglas Frazier, Ramona, CA (US); Prama Agarwal, Irvine, CA (US); Eric John Scheie, Vista, CA (US)

(73) Assignee: Teradata US, Inc., Dayton, OH (US)

(21) Appl. No.: 15/857,061

(22) Filed: Dec. 28, 2017

Related U.S. Application Data
(60) Provisional application No. 62/441,122, filed on Dec. 30, 2016.

(51) Int. Cl. G06F 17/30

(52) U.S. Cl. CPC G06F 17/30283; G06F 17/30563

(57) ABSTRACT

A system for managing data access, processing, and data movement across disparate data sources in a heterogeneous analytical environment. Communication and access between multiple disparate data sources is provided by an interconnect mechanism includes connectors at data source nodes and links established between the connectors to form a fabric, i.e., a set of interconnected nodes, which organizes components into a discrete environment and enables communication between paired data sources of the same or differing type within the environment.

### CROSS REFERENCE TO RELATED APPLICATIONS

This application claims priority under 35 U.S.C. § 119(e) to the following co-pending and commonly-assigned patent application, which is incorporated herein by reference:

Provisional Patent Application Ser. No. 62/441,122, entitled “SYSTEM AND METHOD FOR CONNECTING DISPARATE DATABASE SYSTEMS,” filed on Dec. 30, 2016, by John Douglas Frazier, Prama Agarwal, and Eric Scheie.

### FIELD OF THE INVENTION

The present invention relates to analytical environments including disparate data systems, and more particularly, to managing data access, processing, and data movement across systems in a heterogeneous analytical environment.

### BACKGROUND OF THE INVENTION

As the role of analytics within organizations continues to grow, along with the number and types of data sources and processing requirements, companies face increasing information technology complexity. Much of this complexity arises from the proliferation of non-integrated systems, often from different vendors, each of which is designed for a specific analytic task.

The complications of managing data access, processing, and data movement across disparate data systems are addressed by Teradata Corporation's Unified Data Architecture (UDA), which enables businesses to take advantage of multiple data sources, data types and processing requirements across a Teradata Data Warehouse, Teradata Aster Database and open-source Hadoop implementations. Communication and access between the multiple data sources within the Unified Data Architecture, and beyond to other source systems; is provided by a seamless data fabric and Teradata Corporation's QueryGrid.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of a Teradata Unified Data Architecture (UDA).

FIG. 2 provides a high-level component block diagram identifying QueryGrid components enabling communication between data sources within a Teradata UDA system.

FIGS. 3A and 3B provide an illustration of QueryGrid Manager (QGM) components, and configuration entities maintained by the QueryGrid Manager.

FIG. 4 provides an illustration of QueryGrid Link (QGL) software components running on every node in the UDA system, monitored and managed by the QueryGrid Manager (QGM).

FIG. 5 provides a further illustration of the QueryGrid Link (QGL) subsystem architecture residing on every node in the UDA system.

FIG. 6 provides an illustration of the use of an OGL bridge to connect data sources without direct network connectivity.

FIG. 7 provides an illustration of the use of an OGL bridge to connect data sources across a Wide Area Network (WAN).

### DETAILED DESCRIPTION OF THE INVENTION

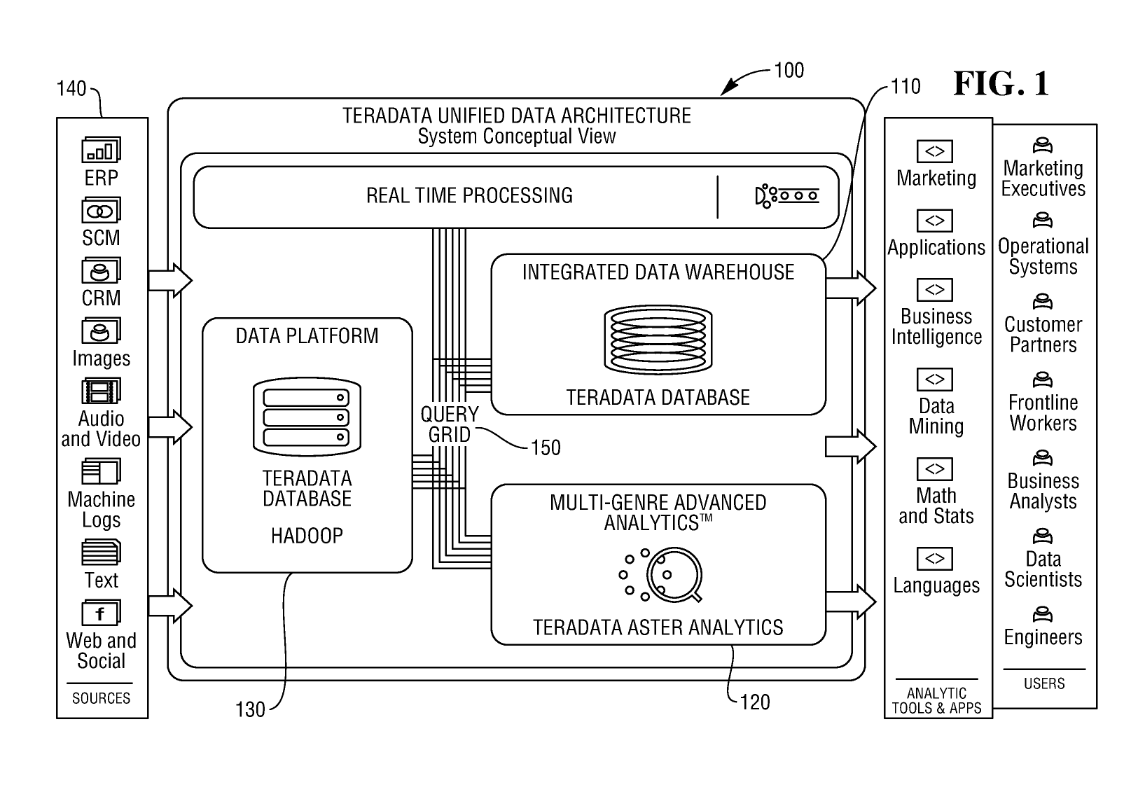

The Teradata Unified Data Architecture™ (UDA) system 100, illustrated in FIG. 1, includes multiple data engines for the storage of different data types, and tools for managing, processing, and analyzing the data stored across the data engines. The UDA system illustrated in FIG. 1 includes a Teradata Database System 110, a Teradata Aster Database System 120, and a Hadoop Distributed Storage System 130.

The Teradata Database System 110 is a massively parallel processing (MPP) relational database management system including one or more processing nodes that manage the storage and retrieval of data in data storage facilities. Each of the processing nodes may host one or more physical or virtual processing modules, referred to as access module processors (AMPS). Each of the processing nodes manages a portion of a database that is stored in a corresponding data storage facility. Each data-storage facility includes one or more disk drives or other storage medium. The system stores data in one or more tables in the data-storage facilities wherein table rows may be stored across multiple data storage facilities to ensure that the system workload is distributed evenly across the processing nodes 115. Additional description of a Teradata Database System is provided in U.S. patent application Ser. No. 14/983,804, titled “METHOD AND SYSTEM FOR PREVENTING REUSE OF CYLINDER ID INDEXES IN A COMPUTER SYSTEM WITH MISSING STORAGE DRIVES” by Gary Lee Boggs, filed on Dec. 30, 2015, which is incorporated by reference herein.

The Teradata Aster Database 120 is also based upon a Massively Parallel Processing (MPP) architecture, where tasks are run simultaneously across multiple nodes for more efficient processing. The Teradata Aster Database includes multiple analytic engines, such as SQL, MapReduce, and Graph, designed to provide optimal processing of the analytic tasks across massive volumes of structured, non-structured data, and multi-structured data, referred to as Big Data, not easily processed using traditional database and software techniques. Additional description of a Teradata Aster Database System is provided in U.S. patent application Ser. No. 15/045,022, titled “COLLABORATIVE PLANNING FOR ACCELERATING ANALYTIC QUERIES” by Derrick Poo-Ray Kondo et al., filed on Feb. 16, 2016, which is incorporated by reference herein.

The Teradata UDA system illustrated in FIG. 1 also includes an open source Hadoop framework 130 employing a MapReduce model to manage distributed storage and distributed processing of very large data sets. Additional description of a data warehousing infrastructure built upon a Hadoop cluster is provided in U.S. patent application Ser. No. 15/257,507, titled “COLLECTING STATISTICS IN UNCONVENTIONAL DATABASE ENVIRONMENTS” by Louis Martin Burger, filed on Sep. 6, 2016, which is incorporated by reference herein. The Hadoop distribution may be one provided by Cloudera, Hortonworks, or Map®.

The Teradata UDA System 100 may incorporate or involve other data engines including cloud and hybrid-cloud systems.

Communication and access between the multiple data engines within the Unified Data Architecture, and beyond to other source systems; is provided by a QueryGrid fabric connector 150.

Data sources 140 shown in FIG. 1 may provide Enterprise Resource Planning (ERP), Supply Chain Management (SCM), Customer Relationship Management (CRM), Image, Audio and Video, Machine Log, Text, Web and Social, Sensor, Mobile App, and Internet of Things (IoT) data to UDA system 100.

### QueryGrid

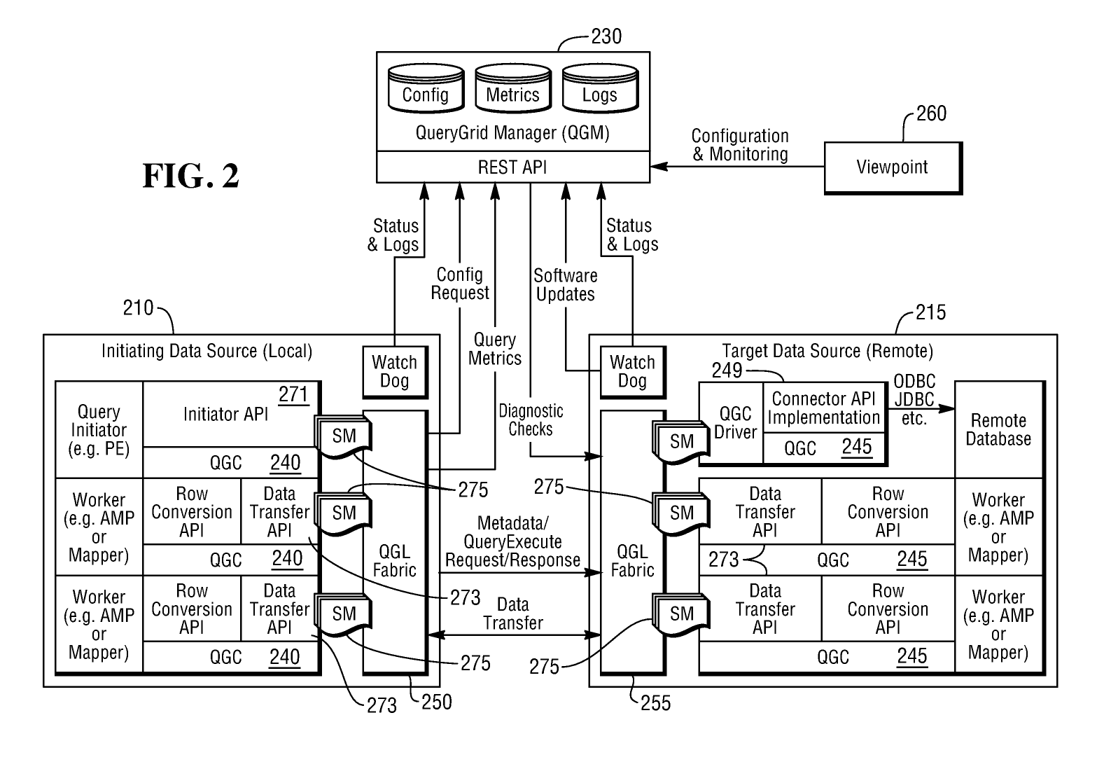

Teradata QueryGrid provides an environment to seamlessly transfer data between a source and a target system in a highly scalable, parallel, secure and fault tolerant manner. It provides bi-directional data transfer capabilities along with query logging and monitoring. FIG. 2 provides a high-level component block diagram identifying components within the QueryGrid architecture for enabling data access, processing, and movement across disparate systems. In the high-level diagram of FIG. 2, these systems include a local data source 210 and remote data source 215. The main structural components of the QueryGrid architecture include QueryGrid Manager (QGM) 230, QueryGrid Connectors (QGC) 240 and 245, and QueryGrid Link (QGL) 250 and 255.

Teradata QueryGrid Manager 230 enables definition, administration, and monitoring of the QueryGrid ecosystem. A portlet in Teradata Viewpoint 260, a single operational view tool for Teradata database, Aster, and Hadoop systems management and monitoring, provides access to the QueryGrid Manager functionality, providing the mechanism to install and configure QueryGrid components and monitor the health of those components.

Teradata QueryGrid Connectors 240 and 245 provide for query processing across data sources. Connectors translate the request language of queries and transform data so that it can be exchanged between different types of systems. Connectors control the execution of queries on target systems and return the results to initiating systems. Connectors run on one or more nodes in a system, and are specific to the system type, such as Teradata or Presto-configured Hadoop. Optional properties allow for configuration refinement of each connector type.

Teradata QueryGrid Links 250 and 255 specify which connectors can communicate with each other and defines rules of data transfer. Each link specifies a pair of connectors: an initiating connector, which is the point from which a query originates, and a target connector, which is the destination point of the query. Likewise, links define initiating and target networks. Each link also specifies a communications policy that defines rules for transferring data between connectors. Optional properties allow for configuration refinement of the initiating or target connector. After Teradata QueryGrid installation, links are utilized to simplify configuration of foreign server definitions in preparation for building queries.

Connectors and links are associated with fabrics. A fabric represents a set of interconnected nodes, all of which run compatible versions of Teradata QueryGrid software over the same port. Each fabric organizes Teradata QueryGrid components into a discrete environment and enables communication between paired data sources of the same or differing type within that environment.

The QueryGrid architecture enables each platform connected to a fabric to function as a peer, where a connected platform can initiate a query on any other platform and include data sources from any platform connected to the fabric.

QueryGrid Manager 230 includes one or more active demon services that are responsible for capturing diagnostic and performance information, managing software updates, maintaining configuration, and managing access to QueryGrid Fabrics.

QueryGrid Links 250 and 255 include a daemon service that provides access to the QueryGrid fabrics. This service, installed on every node wanting to send or receive data to another node, is responsible for registering with QueryGrid Manager 230 to request access to a fabric, providing diagnostic and performance information to the QueryGrid Manager, integrating with QueryGrid connectors, downloading software updates from the QueryGrid Manager, and handling QueryGrid message transport, i.e., connection pooling, routing, encryption, compression, bridging, etc.

Application programming interfaces (APIs) are employed by QueryGrid Connectors 240 and 245 to initiate and participate in QueryGrid queries. QueryGrid Connector APIs include: an initiator API 271 used by the host side of a QueryGrid query to get metadata, e.g., columns, data types, and statistics,) from a remote side, and to execute or abort queries on the remote side; a data transfer API 273 used to send or receive data to or from a QueryGrid Link using shared memory 275; an API used to read from or write to memory buffers in the format expected either by the local side or remote side, depending on where data conversion being performed; and a connector API 279 implemented for remote systems to be able to participate in Query Grid queries.

A more expansive discussion of the structure and operation of the QueryGrid Manager, Connector, and Link components is provided below.

### QueryGrid Manager

QueryGrid Manager (QGM) is a software component that provides monitoring and administration of QueryGrid. Its responsibilities include:
Maintaining configuration details for QueryGrid, such as the systems and connectors that comprise the data fabric and the policies regarding how data is transferred between the systems.
Managing access to QueryGrid. Only QueryGrid Link (QGL) services that have been approved by the QGM will be allowed to make connections send/receive data from other QGLs.
Capturing all QueryGrid performance and diagnostic information, e.g., per query data transfer metrics, QGL logs, etc.
Coordinating upgrades of diagnostic checks of QueryGrid components.
Providing REST APIs for other products or services to integrate, e.g. Teradata Viewpoint.

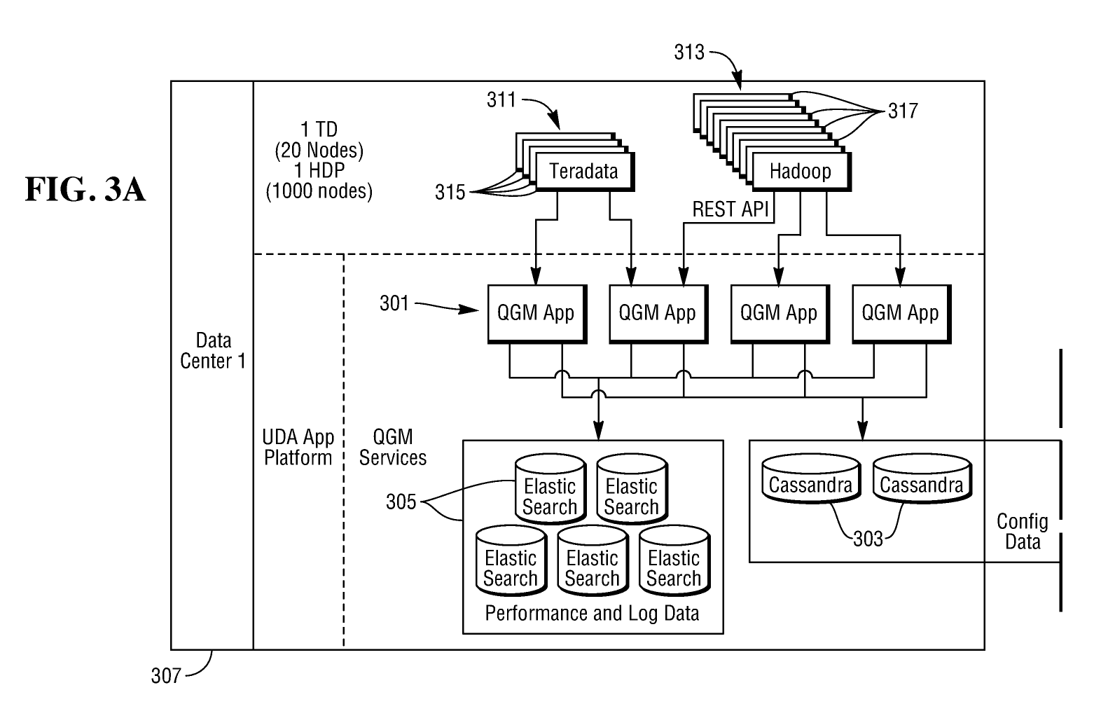

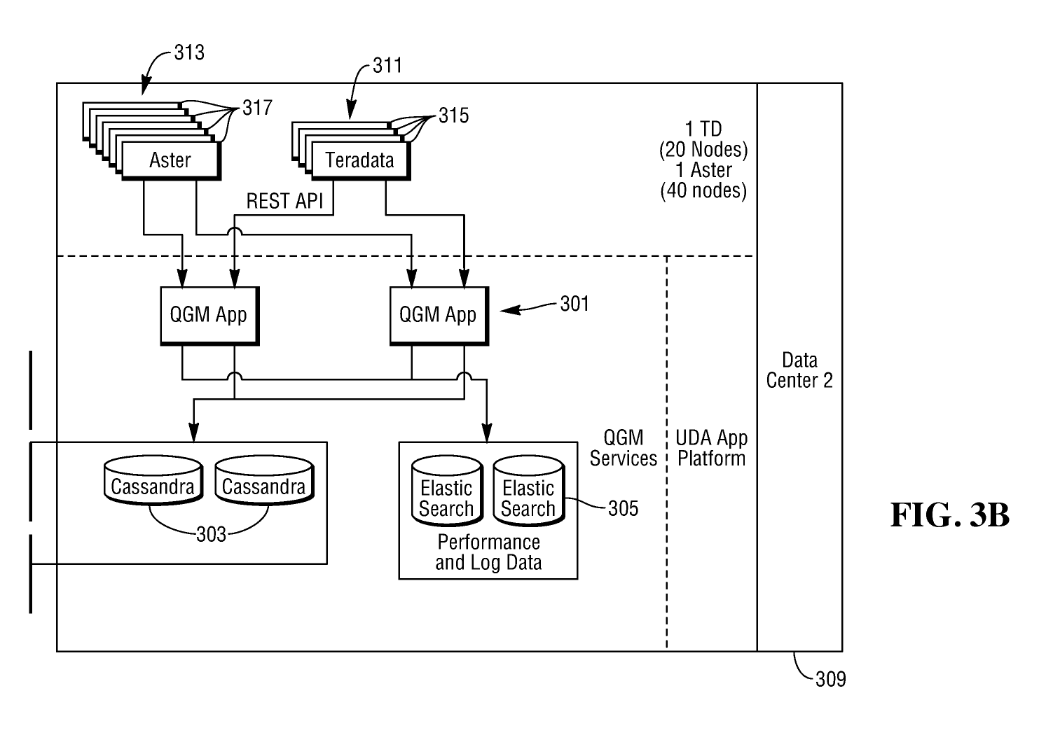

FIGS. 3A and 3B provide an illustration of the QueryGrid Manager components and configuration entities maintained by the QueryGrid Manager.

The QueryGrid Manager is comprised of several components:
QGM Main 301—A Java Spring Boot application that provides the REST APIs (discussed below) and features associated with the QGM. Multiple instances of QGM Main can be run for fault tolerance and scalability.
QGM Setup—A Java command line program that sets up an initial QGM environment or joins a QGM to an existing QGM cluster.
QGM Boot—A Java service used to startup QGM Services in the proper order and monitor and manage those processes. QGM Boot also provides secure inter-node communication channels for ElasticSearch and Cassandra.
Cassandra 303—A Cassandra database used for persisting QueryGrid configuration information.
ElasticSearch—An ElasticSearch data store is used for persisting QueryGrid performance data and logs.
Kibana—A service for searching and analyzing log files.

The QueryGrid Manager is a highly available, fault tolerant, scalable distributed application. The QGM architecture ensures that QueryGrid's configuration is always available to QueryGrid components. Furthermore, the architecture allows for the collection, processing, and storage of performance and diagnostic data captured by the QGM to scale with the size and count of the interconnected systems.

The Query Grid Manager is capable of spanning data centers while still being able to function when potential WAN outages result in network partitions. Diagnostic and log data will not be replicated across the WAN assuming a QGM is data center local to the QueryGrid connected systems.

Not every QGL may have network connectivity to every QGM. QGLs must be able to access at least one QGM instance and should be able to access more to support failover. All QGM instances must have connectivity to each other, e.g., peer-to-peer.

QGMs do not create connections to QGLs except when the QGM is used for the initial install of the QGL watch dog. This architecture allows the QGM to be deployed in a public cloud as it does not need VPN or Firewall access back to the QueryGrid connected systems.

QGM Main 301 is responsible for maintaining QueryGrid Configuration information. QueryGrid Configuration is established by Administrators using a Viewpoint Portlet that calls the QGMs REST API in order to get, create, update, and delete configuration data. Configuration data is persisted to Cassandra 303 so that it can be replicated across multiple instances and data centers for high availability. As Configuration data is small in size, the entire configuration is cached in memory of each QGM Main process for quick access.

Listed below are the different types of configuration entities maintained by the QGM:
Data Centers 307 and 309—The logical name of the Data Center where a system is located. Knowing the Data Center where a system is located allows QueryGrid to know if communication is happening across a LAN or WAN and adjust communication policies accordingly. It is also used to optimize communication between QGLs and the QGM so that QGLs always try to communicate with a LAN local QGM.
Systems 311 and 313—A system, also referred to as a platform, is a set of nodes running common software, such as Hadoop, Teradata Appliance, Aster Appliance, QueryGrid Bridge platform, UDA App Center, etc. A single system can host multiple connectors, e.g., Presto, Hive, Aster all running on a Hadoop platform. Systems are comprised of one or more Nodes, each running QGL software.
Nodes 315 and 317—Nodes run QGL software and are associated with one and only one System. Node objects contain details about the node, such as the available network interfaces.
Connectors—A specific connector type, e.g. Presto, Hive, Teradata, Aster, etc., and version running on one or more nodes of a system.
Fabrics—A set of interconnected nodes all running compatible versions of QueryGrid software on a well-known port number.
Communication Policies—Details for how systems communicate with one another. Communications Policies can range from simple to advanced based on what the user would like to do. Communication Policies are generic, they are not necessarily specific to the systems involved so they can be reused. They can include details about number of streams, whether to enable compression, encryption, or throttling, what networks interfaces to use, and what direction to open connections.
Links—A named configuration that references a QueryPoint connector, a Target Connector, and a communication policy, and defines optional connector properties to use. These named configurations can be referenced by QueryPoint foreign server definitions to simplify their configuration.
UserMapping—A mapping of source usernames to target usernames that is associated with Links.
Networks—A logical network that can be used for QueryGrid communication, containing rules that map the logical network name to physical networks either by interface name or network prefix, and referenced by links to dictate which network interfaces to use for data transfer.
Software—Details about the connector, row converter, and QGL packages available for upgrades.
QGL Properties—Contains per system QGL settings such as buffer sizes, log levels, etc.

With this configuration model, foreign server definitions on Teradata only require one property, the name of the Link configuration that represents the pairing between the local system and the target system.

QueryGrid Configuration entities are persisted into Cassandra tables. Each entity maps to one or more tables. The tables are stored in a “config” key space that has a replication factor equal to the total number of QGM instances. As the configuration data is small, configuration tables only have a single partition so that loading all entities of a specific type can be done quickly and with minimal overhead.

Each QGM instance maintains the entire QueryGrid configuration in memory for quick access. A periodic job runs to make sure that the cache is up-to-date with what's in the Cassandra database. The job checks each record's last modified time for differences and updates the cache accordingly. The cache refresh job is configured to run every two minutes by default. In addition, whenever a configuration change is made via the REST API, the configuration change is broadcast to the other QGM instances so that their cache memories reflect any changes made.

The QGLs send heartbeats to the QGM to report status and performance metrics and the QGM responds with details about actions the QGL need to take if any. There are two types of heartbeats, WatchDog heartbeats and Fabric instance heartbeats.

Watchdog heartbeats are sent to the QGM by the QGL Watchdog process. This heartbeat includes the status of the Connector Drivers and Fabrics that the Watchdog process is managing. The QGM response to the heartbeat includes details of the fabrics and connector drivers that should be running on that node. The response also contains the list of QGM addresses to use for communication in the order that they should be attempted to keep QGL to QGM communication balanced even in the event of failures.

Fabric heartbeats are sent to the QGM by the QGL Fabric instances. This heartbeat includes the metadata and performance metrics associated with active queries. Query performance data should be included in the QGL heartbeat until the query is complete and the QGM has successfully acknowledged the heartbeat containing the final performance data for the query. The QGM response to the heartbeat contains the last modified time for configuration data so that the QGL can determine if it needs to reload its configuration cache. The response also contains the list of QGM addresses to use for communication in the order that they should be attempted to keep the QGL to QGM communication balanced among the QGMs. Lastly, the response contains the details of any diagnostic checks that the node should perform.

Query Performance data is captured via the QGL fabric heartbeat messages. These messages include metrics about each active query such as CPU consumed, bytes transferred, durations, row counts, compression ratios, etc. These messages also include meta data and diagnostic data about the queries such as Query text, source user, session IDs, data exchange details, errors, etc. These per QGL query details are indexed in ElasticSearch before receipt of the heartbeat is acknowledged by QGM. A periodic job runs to aggregate all per QGL query details into an overall query summary record that is also indexed in ElasticSearch.

The QGM will periodically summarize the data captured for a particular query from all QGLs and save this summary data to an ElasticSearch index so that it can returned in REST API requests. The frequency that summarization is performed is configurable in the Viewpoint UI but will default to 30 seconds. Summarization is performed by the QGM leader for the data center hosting the QueryPoint system (See Leader Election for more details). Since the per QGL details for a query can be split across Data Centers, aggregation will be performed using a TribeNode so that the data from all data centers will be incorporated into the summary record (See ElasticSearch TribeNode). The summary record will then be saved to a index located on the QueryPoint local Elastic Search cluster.

QGM Main provides REST APIs for accessing query summary and detail information. The API will provide access to the list of active queries as well as access to a historical log of past successful and failed queries based on a requested time range. Individual query data returned from the REST API will include both meta data about the query, e.g., QueryText, users, session ids, etc., as well as the associated performance metrics.

Since Query Grid is a distributed system running on potentially thousands of nodes, it can be very difficult to diagnosis problems and determine root causes when errors occur. To improve supportability and diagnosis of issues, the QGM accepts log files from all QueryGrid components that can be searched and presented in a uniform view.

The QGM will expose a REST API that QGLs can use to send their log files to be indexed by Elastic Search. Log files will also be stored and indexed in the Data Center where they were generated, assuming the QGM is data center local.

In addition, the QGM submits its own logs files to ElasticSearch for indexing using a log back ElasticSearch appender.

QGLs submit logs in the form of a JSON array via a REST API, where each entry in the array is a JSON object representing the log data model (see Log Data Model). QGLs will submit logs to the QGM when either of the following conditions occur:
Logs messages fill the in-memory log buffer, e.g. 10 MB.
A configurable period of time elapses since the logs were last sent, e.g. 5 minutes.

After receiving the logs, the QGM will bulk insert them into an Elastic Search index and will return “200 OK” if successful. If the QGL gets an error message back, it can wait 30 seconds and try again. If the QGM never responds within a configurable timeout, the QGL can close the connection and retry. The QGM will respond with “429 Too many requests” if it is unable to process the request before the timeout is exceeded (see Handling Back Pressure for more details) so clients should only timeout in the event of a failure. If the QGL is unable to connect to the QGM, it can try connecting to another QGM co-located in the data center.

Each log submission is placed into a queue and a dedicated pool of threads will be used for consuming and inserting log data into Elastic Search. The size of the pool will dynamically grow or shrink depending on the load. Since log capture is one of the least mission critical features provided by the QGM, it may scale down log consumption in favor of other QGM workloads.

The following topics cover a range of internal features to the QGM that support the implementation of the features described above.

Inter-QGM Messaging:

Inter-QGM messaging is used for maintaining the distributed cache and for coordinating activities such as diagnostic checks. The messaging is implemented using the QGM REST API. Each QGM creates an internal message queue and thread for each remote QGM. When a QGM wants to send a message to all other QGMs, it adds the message to the internal queue associated with each remote QGM. This triggers the remote QGM specific thread monitoring the queue to wake up and send the message to remote using an HTTP POST. If the queue contains multiple messages, multiple messages can be batched together in a single POST. If the message send fails or times out, the message is re-sent until it is either successfully acknowledged or the message time-to-live expires. On the consuming side, the messages are added to the queues of the target handlers and processed asynchronously.

Leader Election:

There are certain tasks like query summarization or log pruning that only need to be performed by a single QGM either per data center or globally. As such, a per Data Center QGM leader and Global QGM leader are chosen to perform these specific tasks. The algorithm used to choose the leaders is kept simple as the leaders are not used to guarantee consistency of operations, rather it is just used as an optimization. Thus, it is okay for network partitions to result in two different QGMs thinking they are the Global leader.

Leader election works as follows. Each QGM is assigned a UUID when joining the cluster. The QGM with the least lexicographical ordered UUID becomes the global leader by default. Similarly, the QGM with the least lexicographical ordered UUID in a particular data center becomes the data center leader. Each QGM periodically adds the current timestamp to a Cassandra table as a form of heartbeat. A periodic job runs in each QGM to check this heartbeat table to see if a recent entry exists for the least lexicographical ordered UUID. If one is not found, then it moves on to the next least ordered QGM until one is found to be online Because the QGM order across QGMs is consistent and because the heartbeat information is eventually consistent, all QGMs, in the absence of network partitions, agree on who are the global and data center leaders.

QGM Load Balancing:

As there could be thousands of QGLs all sending heartbeats and log data, we want to be able to scale up the number of QGMs and make sure that the work is split evenly between them. QGLs will be given a list of the QGM addresses in the order that they should be tried. If the first QGM in the list is available, then that QGM that should be used exclusively. If the first one is not available, then the second one should be used and so on. When QGL's are not talking with their primary QGM, they should periodically retry their primary QGM and resume communication with it when its detected to be back online.

The order of the QGM addresses assigned to each QGL is different as a way to statically load balance the work sent to each QGM, even in the event of QGM failures. The QGLs are given a permutation of the data center local QGMs first, and then a permutation of the non-local QGMs second so that communication is kept within the local data center when possible.

This static balancing is based on the assumption that all QGMs have similar resources available to them which may not always be true. As such, the load balancing solution may be made more dynamic post MVP.

### QueryGrid Connector

A Query Grid Connector, or QGC, is a platform specific connector designed to handle connecting two disparate systems to exchange data instructions using SQL queries or object APIs for non-SQL engines. The QGC is the component that handles the remote execution of a sub-query for the local database. The QGC controls the sequence of steps needed to execute the query on the remote database and return the result set. Each type of query, e.g., SELECT, EXPLAIN, INSERT, etc., has a specific execution flow, associated messages, and specific modules and methods to support the query.

The goal of the QueryGrid design is to provide a standard protocol so that a QueryPoint, the initiating point for a query, may be added by supplying one QGC that provides a local initiator and remote connector. Additions of new data types require a change of the data conversion library to provide a mechanism to convert the new data type into the type supported by each QueryPoint. This library must be updated on all QueryPoints accessing the source of the new data type. Another goal for the QueryGrid design is to provide a Software Development Kit (SDK) so that other Partners or customers can implement a QGC for a unique QueryPoint.

The description which follows explains the connection and exchange of data instructions between Teradata and Presto-configured Hadoop data sources. This connection allows a client to connect to either Teradata or Presto and initiate a query that can access either Teradata or Presto data sources. This connection would provide a user with access from Teradata-to-Teradata, Teradata-to-Presto, Presto-to-Teradata, and Presto-to-Presto. Supported SQL statements may include:
CREATE FOREIGN SERVER
SELECT
SELECT from FOREIGN TABLE
SELECT with EXPORT CLAUSE
INSERT
HELP FOREIGN (SERVER, DATABASE, TABLE) (Teradata syntax to LIST dictionary information)
SHOW SCHEMAS/TABLES/COLUMNS (Presto syntax to LIST dictionary information)
EXPLAIN SELECT
EXPLAIN INSERT
DDL, DCL statements (like CREATE TABLE, GRANTS, DROP, etc)
Execute foreign Function is not supported in MVP.

The following paragraphs provide several examples, described by QueryPoint-to-target, how a QueryPoint statement is formed by the user. The terms import and export refer to the underlying QueryGrid operation which are named import and export. The import and export terms are used since not all QueryGrid operations are expected to be SQL based, for example MongoDB.

Teradata-to-Presto Select.

Import request initiated on Teradata using the foreign server object to fetch data from remote Presto system. The push down will be partly decided by the remote system's capabilities, and partly based on the local system's optimizer rules. For Teradata to Presto select query, the optimizer decides the pushdown predicates which are then evaluated for final remote query pushdown based on what is supported by the remote.

```
SELECT CAST(Price AS DECIMAL (8,2))
      , mileage
      , CAST(make AS VARCHAR(20))
      , CAST(model AS VARCHAR(20))
FROM cardata@presto1 WHERE make=’Buick’;
```

| price | mileage | make | model |
|---|---|---|---|
| 17314.10 | 8221 | Buick | Century |
| 17542.04 | 9135 | Buick | Enclave |

Teradata-to-Presto Select with Foreign Table.

Import request initiated on Teradata using the foreign table push down query to fetch data from remote Presto system. This is a pass-through query and will not be parsed on Teradata end but might need to be regenerated by the QueryBuilder on the remote, for example, to qualify table name with catalog name

SELECT * FROM FOREIGN TABLE (SELECT make, model FROM
default.cardata where
make = ‘Buick’)@QG_presto1 AS dt;

| make | model |
|---|---|
| Buick | Century |
| Buick | Enclave |

Presto-to-Teradata Select.

Import request initiated on Presto to fetch data from remote Teradata system. Query predicates to be pushed are provided to the connector in the Constraint class by the presto server and used for pushdown to remote TD.

SELECT MAKE, MODEL FROM QG_TD1.DB1.TD_CARDATA
WHERE MAKE = ‘BUICK’;

| make | model |
|---|---|
| Buick | Century |
| Buick | Enclave |

Teradata-to-Presto Insert.

Export request initiated on Teradata using the foreign server object to insert data into remote Presto system.

INSERT INTO new_cardata@QG_Presto1 SELECT * FROM
td_cardata;

Presto-to-Teradata Insert.

Export request initiated on Presto to insert data into remote Teradata system.

INSERT INTO QG_TD1.DB1.TD_CARDATA SELECT * from
hive.default.cardata;

Teradata-to-Presto Explain Select.

Generates an explain plan from the remote Select query and embeds into the query plan on the local Teradata system. Please note this is a sample explain output, the remote plan will be different for an actual implementation of the presto connector, QGRemote running on presto.

EXPLAIN SELECT FROM cars@QG_Presto1

WHERE price>10; Explanation
1) First, perform an all-AMPs RETRIEVE step executing table operator TD_SYSFNLIB.QGCInitiatorImport with a condition of (“cars.PRICE>1.00000000000000E 001”).

< BEGIN EXPLAIN FOR REMOTE QUERY -->
Remote Query Text: create table qgremote.default.temporarytable as
select name, price from hive.default.cars where price > 10
- Output[name, price] => [name:bigint, price:double]
- Exchange[GATHER] => name:bigint, price:double
- Filter[(“price” > 10.0)] => [name:bigint, price:double]
- TableScan[hive:hive:default:cars, originalConstraint = (“price”
>10.0)] =>[name:bigint, price:double]
LAYOUT: hive
name := HiveColumnHandle{clientId=hive, name=name,
hiveType=bigint, hiveColumnIndex=0, partitionKey=false}
price := HiveColumnHandle{clientId=hive, name=price,
hiveType=double, hiveColumnIndex=1, partitionKey=false}
<-- END EXPLAIN FOR REMOTE QUERY >

The size of Spool 1 is estimated with low confidence to be 8 rows (296 bytes). The estimated time for this step is 0.15 seconds.
2) Next, perform an all-AMPs RETRIEVE step from Spool 1 (Last Use) by way of an all-rows scan with a condition of (“cars.PRICE>1.00000000000000E 001”) into Spool 2 (group_amps), which is built locally on the AMPs. The size of Spool 2 is estimated with low confidence to be 8 rows (504 bytes). The estimated time for this step is 0.16 seconds.
3) Finally, send out an END TRANSACTION step to all AMPs involved in processing the request.
   The contents of Spool 2 are sent back to the user as the result of statement 1. The total estimated time is 0.31 seconds.

Teradata-to-Presto Explain Insert.

Generates an explain plan for the remote Insert query and embeds with the local Teradata system. Please note this is a sample explain output, the remote plan will be different for an actual implementation of the presto connector, QGRemote running on presto.

EXPLAIN INSERT INTO cars@QG_Presto1 SELECT
FROM tempcardata; Explanation
   1) First, perform an INSERT into Spool 3.
   2) Next, perform an all-AMPs RETRIEVE step from Spool 3 (Last Use) by way of an all-rows scan executing table operator TD_SYSFNLIB.QGCInitiatorExport with a condition of (“(1=1)”) into Spool 2 (used to materialize view, derived table, table function or table operator make) (all_amps), which is built locally on the AMPs.

< BEGIN EXPLAIN FOR REMOTE QUERY -->
Remote Query Text: insert into hive.default.cars select * from
qgremote.default.temporarytable
- Output[rows] => [rows:bigint]
- TableCommit[hive:hive:default.cars] => [rows:bigint]
- Exchange[GATHER] => partialrows:bigint, fragment:varbinary
- TableWriter => [partialrows:bigint, fragment:varbinary]
name := name
price := price
- Exchange[REPARTITION] => name:bigint, price:double
- Project => [name:bigint, price:double]
name := null
- TableScan[hive:hive:default:car1, originalConstraint = true] =>
[price:double]
LAYOUT: hive
price := HiveColumnHandle{clientId=hive, name=price,
hiveType=double,
hiveColumnIndex=0, partitionKey=false}
<-- END EXPLAIN FOR REMOTE QUERY >

The size of Spool 2 is estimated with high confidence to be 1 row (39 bytes). The estimated time for this step is 0.03 seconds.
3) Perform an all-AMPs RETRIEVE step from Spool 2 (Last Use) by way of an all-rows scan into Spool 4 (Last Use), which is built locally on the AMPs. The size of Spool 4 (Last Use) is estimated with high confidence to be 1 row (71 bytes). The estimated time for this step is 0.08 seconds.
4) Finally, send out an END TRANSACTION step to all AMPs involved in processing the request.
   No rows are returned to the user as the result of statement 1.

Teradata-to-Presto HELP FOREIGN SERVER.

Fetches the schema(databases) from the catalog associated with the server.

help foreign server QG_Presto1;
Databases
default
information_schema

Teradata-to-Presto HELP FOREIGN DATABASE.

Fetches the tables from the specified database.

help foreign database “default”@QG_Presto1;
Tables
buses
ca120453
jing_part_tab1
prama_part_tab1
tbig_1row
web_sales_part1_orc

Teradata-to-Presto HELP FOREIGN TABLE.

Fetches the column information of the specified table.

help foreign table tbig_1row@QG_Presto1;

| Column | Type | Null | Partition Key | Comment |
|---|---|---|---|---|
| Id | bigint | true | false | |
| firstname | varchar | true | false | |
| lastname | varchar | true | false | |
| gender | varchar | true | false | |
| Age | bigint | true | true | |

Presto-to-Teradata SHOW SCHEMAS.

Fetches the list of schemas(databases) from the remote Teradata system. This is equivalent to T2P Help Foreign Server query. It internally generates a query to access the DBC.DatabasesV system view.

SHOW SCHEMAS FROM QG_TD1 −> submits TD query −> select
databasename from dbc.DatabasesV;

Presto-to-Teradata SHOW TABLES.

Fetches the list of tables in a specified database from the remote Teradata system. This is equivalent to T2P Help Foreign Database query. It internally generates a query to access the DBC.TablesVX system view.

SHOW TABLES FROM QG_TD1.schemaname −> submits TD query −>
select tablename from DBC.TablesVX t where t.DatabaseName =
‘schemaname’ and t.TABLEKIND IN (′O′,′T′) AND t.COMMITOPT NOT
IN (′D′, ′P′);

Presto-to-Teradata SHOW COLUMNS.

Fetches the list of columns and associated information for a table from the remote Teradata system. This is equivalent to T2P Help Foreign Table query. It internally generates a query to access information from DBC.ColumnsVX system view.

SHOW COLUMNS FROM QG_TD1.schemaname.tablename −> submits
TD query −> select c.column_name, c.column_type, c.column_size
from dbc.ColumnsVX c join dbc.TablesVX t on c.DatabaseName =
t.DatabaseName and c.TableName = t.TableName where
c.DatabaseName = ‘schemaName’ and c.TableName =
‘tablename’ and t.TABLEKIND IN (′O′,′T′) AND t.COMMITOPT NOT
IN (′D′, ′P′) order by columnid;

Teradata-to-Presto Execute Foreign Query.

Executes the DDL/DCL queries on the remote presto system using a predefined stored procedure and underlying function. It will require a dedicated foreign server to execute these queries.

CALL SYSLIB.QGCExecuteForeignSP(‘create table tab1(c1 int, c2
string)’, ‘QG_Presto1’);

Query Grid Connector comprises various components that are responsible for initiating a query, mapping data types, processing data and converting to proper format and reading/writing data from/to data sources. Different components and their various responsibilities include:

QGC Driver.

A process running on remote end that loads the connector, establishes shared memory channel with QGL, reads messages off shared memory, invokes the appropriate method to process each request and sends responses.

There will be a Java driver for systems running native java connectors and a C++ driver for systems with native CPP connectors. Driver gets loaded and started up as part of QGL startup via watchdog process. This driver process reads messages from shared memory. It will load the connector library and invoke connector APIs to process each request based on the message type in the data. The message payload is de-serialized as part of message read. Connector API returns a response which is then serialized and packed in the message buffer format along with the control and monitor message block and written to the shared memory to be sent back to the QGL and local connector. QGC driver follows a message exchange protocol with QGL for each request and response as described in Messaging Protocol.

Local QGC Connector.

Connector running on local end initiating the query. It establishes shared memory channel with QGL, establishes connector session, writes messages/data to shared memory to be sent to the remote and processes responses/data.

Local QGC connectors on the Teradata end are C++ table operator functions and associated libraries that sets up the connection and shared memory with QGL, prepares the initiating request and sends it to the remote via QGL, receives and processes the response. It sends and receives data and EOF messages/responses as part of data transfer phase.

Initiator import and export connector contract and execute functions are table operator functions chosen over regular UDFs since they are much faster than UDFs as they are allowed to execute within the dbs code stack without the added penalty of creating a different udf stack.

These functions are wrappers to the QGNG QGC connector libraries that are installed on each TD node. The connector will load the connector library functions that are responsible for the actual functionality and data processing.

The initiator functions identified below are added to support QueryGrid QGC:
QGCInitiatorImport: Initiator Import function that is invoked when the query is initiated from Teradata and needs to access metadata and fetch data from a remote host. This common initiator import connector function will be used to import data from any remote host.
QGCInitiatorExport: Initiator Export function that is invoked when the query is initiated from Teradata and needs to access metadata and export data to a remote host. This common initiator export connector function will be used to export data to any remote host.
QGCExecuteForeignQuery: Function that is invoked when a Stored Procedure is invoked to execute a DDL/DML request to the remote system. This is to provide flexibility to execute CreateTable/DropTable/Grants/etc from local Teradata on to the remote host.

The functions are indirectly invoked when the foreign server QueryGrid query is submitted by the Teradata user. Teradata has a foreign server construct that specifies the communication protocol between local and remote server and specifies the import and export connector to use for processing. DBA defines these foreign servers to be used by the end user. With QueryGrid, these servers will have to be defined to use the new connectors and the associated external name value pairs that identify the connection/configuration properties. Foreign servers can be configured with an import and/or export table operator function.

CREATE FOREIGN SERVER Presto_1
USING
LINK(‘td1_presto1’)
DO IMPORT WITH TD_SYSFNLIB.QGCInitiatorImport,
DO EXPORT WITH TD_SYSFNLIB.QGCInitiatorExport;

These operators will go through the various contract phases and data execution phases.

Contract Phase (DDL/GetALLCols/Complete):
DDL Phase: Set up the configuration NVPs, establishes a shared memory channel and fetches request UUID from QGL for the create foreign server request. It sends a request to remote QGC to validate connection and receives a validate response. An error will be returned to DBS if connection failed.
GetAllCols Phase: Set up the configuration NVPs, establishes a shared memory channel and fetches request UUID from QGL for the import request. It sends a request to fetch metadata and receives the metadata response containing the column definition. It then converts the result to TD output column format, saves the contract context and sets the output column info. The phase will also be used for help foreign requests to retrieve the metadata of the rows describing the list of database, schemas or columns associated with a table.
Complete Phase: Local QGC sends a request to fetch explain or stats information and process the response.

Execute Phase: Master AMP sets up the request to send the import or export DATAEXEC request to remote after sending the node information. All AMPs sync and send a message to QGL to indicate readiness to transfer data. Each AMP reads data buffers during import and processes to transmit rows back for spooling or writes data buffers during export. EOF message/response is exchanged indicating no more data. Since the master AMP is responsible for sending the import/export request as well as for data transfer, this AMP will ping the shared memory channel used for DataExec message from time to time to ensure ACK, RESP or ABORT, ERROR message is not received. When done, master AMP receives the DATAEXEC response message and sends commit message to QGL to indicate resources can be cleaned up for the query.

The local QGC connector on Presto are called QGInitiator. The metadata API is modified to open shared memory channel with QGL and send metadata request to remote, receive the response and set the column metadata. QueryBuilder and ExecuteQuery prepare the import/export request and send to remote. Each worker on presto stand up and will receive data. Data streaming APIs (recordSink, PageSource methods) are modified to read/write data buffers and convert using a data conversion library. EOF message and response will trigger the end of data transfer at which point the shared memory handle will be closed.

Remote QGC Connector.

This is the connector running on remote presto that is receiving requests from initiator end and is started to read/write data. It establishes shared memory channel with QGL, processes data to convert to appropriate format and reads/writes from/to shared memory for transfer of data to the other end.

Communication is supported to either the remote Teradata or Presto system which means that there will be a remote connector that is implemented for Teradata and one for Presto. This connector is invoked when the request is received by the driver installed on the remote node.

Remote QGC connectors on Teradata are C++ table operator functions and connector libraries that sets up the connection and shared memory with QGL and sends and receives data and EOF messages/responses. The data conversion by default will be at the remote end but Post MVP, we will also add the hooks to let the user choose such that TD resources can be utilized for conversion, if needed.

The connector library will be loaded by the QGC driver when the request arrives. It is responsible for processing the metadata and import/export execution requests. Metadata is retrieved and mapped to the global data types and returned back to the driver for packing it in the response buffer. Import/export execution requests start the remote table operator functions pre-installed in Teradata. These functions will be responsible for transferring the data using QGC-QGL shared memory communication.

The remote functions identified below are added to support QGNG QGC.
QGCRemoteImport: Remote Import function that is invoked when the query is initiated by a remote host and needs to transfer the data to this local Teradata system. This common remote import function will be used to transfer data from any remote host.
QGCRemoteExport: Remote Export function that is invoked when the query is initiated by a remote host and needs to access data from the local Teradata system. This common remote import function will be used to export data to any remote host.

The remote QGC connector on Presto is a Java Presto connector that is loaded by the QGC driver using connector factory when the request arrives. This connector is responsible for processing the metadata and import/export execution requests. Metadata is retrieved and mapped to the global data types and returned back to the driver for packing it in the response buffer. Import/Export requests in turn invoke the QueryGrid connector registered into presto called QGRemote for data processing. This connector uses the framework and refactors the greyhound connector code. The data streaming APIs in the greyhound connector processes rows and uses the data conversion library to transfer data using QGC-QGL shared memory communication. The connector will be invoked by the QGC driver as part of DATAEXEC messages. The connection information including details like request UUID, NodeInfo of the local QGC and configuration parameters will be set in the session as NVP before invoking the QGRemote connector and will be used when transferring data.

QueryBuilder will construct query of the form ‘create table QG_GHconnector.default.temporarytable as select * from (select query from sourcetable); for the import processing which will pipeline data straight for processing and send to TD nodes, without saving temporary results on disk.

Data will be written as DATA message to shared memory. Connector keeps track of response messages and sends EOF when data is exhausted. EOF_RESP triggers completion of data processing for that worker.

Data Type Mapping.

Mapping table that defines each data type uniquely and has a mapping from one source type to the other for each supported conversion.

Data Conversion Library.

Encoding/decoding routines to convert data to/from source and destination buffer formats. The conversion library can be installed on local and/or remote nodes. The metadata phase indicates if the remote provides conversion capability and the data format it uses for data transfer. This release of QGNG will only support data transfer in INDIC format over the wire.

The message flow between QGC and QGL for various import and export parsing and data transfer steps is now described. As part of an import operation, both initiator and remote connectors send/receives various messages as part of metadata and execution phases.

Initiator Connector—Metadata Phase.

Local QGC establishes a connection with local QGL and exchanges the session information and requests for a UUID associated with the request. QGC sends the Link name, along with Link version if provided, in shared memory before making a metadata request for retrieving remote table/query metadata, help, explain, stats, execution of foreign DDL/DML requests or for validating target system connection.

1. Opens shared Memory handle, performs auth handshake

2. Sends QGC_SESSION_MSG

3. Receives QGC_SESSION_RESP

4. Sends QGC_TARGET_HOSTINFO_MSG

5. Receives QGC_SUCCESS_MSG

6. Sends QGC_METADATA_REQ

7. Receives QGC_METADATA_RESP

8. Closes shared memory handle

Initiator Connector—Data Execution Phase—Control Worker.

Master worker on the local QGC sends the link name, along with Link version if provided, and UUID in shared memory before sending the node information and the data execute message to kick-off the import operation on the remote QGC.

1. Open shared Memory handle, performs auth handshake

2. Sends QGC_TARGET_HOSTINFO_MSG

3. Receives QGC_SUCCESS_MSG

4. Sends QGC_TARGET_NODEINFO_MSG

5. Receives QGC_SUCCESS_MSG

6. Sends QGC_DATAEXEC_REQ

7. Receives QGC_DATAEXEC_RESP

8. Close shared Memory handle

Initiator Connector—Data Execution Phase—All Workers Processing Data.

All workers on the local QGC prepare for data transfer by sending the configuration information and UUID to local QGL followed by an IMPORT message indicating readiness to receive data. They receive one or more data message buffers and receive EOF request indicating no more data will be received on this channel Workers send EOF response and close the shared memory handle.

1. Open shared Memory handle, performs auth handshake

2. Sends QGC_TARGET_HOSTINFO_MSG

3. Receives QGC_SUCCESS_MSG

4. Sends QGC_IMPORT_REQ

5. Receives one or more QGC_DATA_MSGs

6. Receives QGC_EOF_REQ

7. Sends QGC_EOF_RESP

8. Close shared Memory handle

Remote Connector—Metadata Phase—Driver.

Remote driver receives the configuration information followed by the metadata request. It loads the connector or reuses from the cache and invokes the desired connector API to process the request and send back the metadata response.

1. Accept shared memory handle, performs auth handshake

2. Receives QGC_TARGET_HOSTINFO_MSG

3. Sends QGC_SUCCESS_MSG

4. Receives QGC_METADATA_REQ

5. Sends QGC_METADATA_RESP

6. Closes shared memory handle

Remote Connector—Data Execution Phase—Driver.

Remote driver receives the configuration information followed by the data execute request. It loads the connector or reuses from the cache and invokes the desired connector API to start the remote parallel query on the target system. It sends the data execute ACK at regular intervals with remote query/session info and sends the data execute response when the remote query finishes.

1. Accept shared memory handle, performs auth handshake

2. Receives QGC_TARGET_HOSTINFO_MSG

3. Sends QGC_SUCCESS_MSG

4. Receives QGC_TARGET_NODEINFO_MSG

5. Sends QGC_SUCCESS_MSG

6. Receives QGC_DATAEXEC_REQ

7. Sends QGC_DATAEXEC_ACK at regular intervals to QGL

8. Sends QGC_DATAEXEC_RESP

9. Closes shared Memory handle

Remote Connector—EXPORT Data Phase—All Workers for Responder or Remote Connector Processing Data.

The query executed on the remote through remote parallel query invoked by the driver will bring up the worker QGCs on remote nodes. All workers on the remote QGC will send the local QGC node information received by the driver to local QGL and send the EXPORT request indicating readiness to send data. One or more data buffers will be sent before sending EOF message. Worker receives EOF response, closes the shared memory handle and goes away.

1. Open shared Memory handle, performs auth handshake

2. Sends QGC_TARGET_NODEINFO_MSG

3. Receives QGC_SUCCESS_MSG

4. Sends QGC_EXPORT_REQ

5. Sends one or more QGC_DATA_MSGs

6. Sends QGC_EOF_REQ

7. Receives QGC_EOF_RESP

8. Close shared Memory handle

As part of an export operation, both initiator and remote connectors send/receives various messages as part of metadata and execution phases.

Initiator Connector—Metadata Phase. Local QGC establishes a connection with local QGL and exchanges the session information and requests for a UUID associated with the request. QGC sends the link name, along with link version if provided, in shared memory before making a metadata request for retrieving remote table/query metadata or for validating target system connection.

1. Opens shared Memory handle, performs auth handshake

2. Sends QGC_SESSION_MSG

3. Receives QGC_SESSION_RESP

4. Sends QGC_TARGET_HOSTINFO_MSG

5. Receives QGC_SUCCESS_MSG

6. Sends QGC_METADATA_REQ

7. Receives QGC_METADATA_RESP

8. Closes shared memory handle

Initiator Connector—Data Execution Phase—Master Worker.

Master worker on the local QGC sends the link name, along with link version if provided, and UUID in shared memory before sending the node information and the data_execute message to kick-off the export operation on the remote QGC.

1. Accept shared memory handle, performs auth handshake

2. Receives QGC_TARGET_HOSTINFO_MSG

3. Sends QGC_SUCCESS_MSG

4. Receives QGC_TARGET_NODEINFO_MSG

5. Sends QGC_SUCCESS_MSG

6. Receives QGC_DATAEXEC_REQ

7. Receives QGC_DATAEXEC_ACK at regular intervals from QGL

8. Receives QGC_DATAEXEC_RESP

9. Closes shared Memory handle

Initiator Connector—Data Execution Phase—All Workers Processing Data.

All workers on the local QGC prepare for data transfer by sending the configuration information and UUID to local QGL followed by an EXPORT message indicating readiness to transferring data. They send one or more data message buffers and send EOF request indicating no more data will be sent on this channel Workers receive EOF response. They sync when all data transfer is complete and master worker sends the commit message to QGL such that it can be communicated to remote QGL and QGC and the resources can be cleaned up.

1. Open shared Memory handle, performs auth handshake

2. Sends QGC_TARGET_HOSTINFO_MSG

3. Receives QGC_SUCCESS_MSG

4. Sends QGC_EXPORT_REQ

5. Sends one or more QGC_DATA_MSGs

6. Sends QGC_EOF_REQ

7. Receives QGC_EOF_RESP

8. When all workers have completed sending data, master
AMP sends QGC_COMMIT_MSG to QGL

9. Closes shared Memory handle

Remote Connector—Metadata Phase—driver.

Remote driver receives the configuration information followed by the metadata request. It loads the connector or reuses from the cache and invokes the desired connector API to process the request and send back the metadata response.

1. Accept shared memory handle, performs auth handshake

2. Receives QGC_TARGET_HOSTINFO_MSG

3. Sends QGC_SUCCESS_MSG

4. Receives QGC_METADATA_REQ

5. Sends QGC_METADATA_RESP

6. Closes shared memory handle

Remote Connector—Data Execution Phase—Driver.

Remote driver receives the configuration information followed by the data execute request. It loads the connector or reuses from the cache and invokes the desired connector API to start the remote parallel query on the target system. It sends the data execute ACK at regular intervals with remote query/session info and sends the data execute response when the remote query finishes.

1. Accept shared memory handle, performs auth handshake

2. Receives QGC_TARGET_HOSTINFO_MSG

3. Sends QGC_SUCCESS_MSG

4. Receives QGC_TARGET_NODEINFO_MSG

5. Sends QGC_SUCCESS_MSG

6. Receives QGC_DATAEXEC_REQ

7. Sends QGC_DATAEXEC_ACK at regular intervals to QGL

8. Sends QGC_DATAEXEC_RESP

9. Closes shared Memory handle

Remote Connector—IMPORT Data Phase—All Workers for Responder or Remote Connector Processing Data.

The query executed on the remote through remote parallel query invoked by the driver will bring up the worker QGCs on remote nodes. All workers on the remote QGC will send the local QGC node information received by the driver to local QGL and send the IMPORT request indicating readiness to receive data. One or more data buffers will be received before receiving EOF message. Worker sends EOF response, closes the shared memory handle and goes away.

1. Open shared Memory handle, performs auth handshake

2. Sends QGC_TARGET_NODEINFO_MSG

3. Receives QGC_SUCCESS_MSG

4. Sends QGC_IMPORT_REQ

5. Receives one or more QGC_DATA_MSGs

6. Receives QGC_EOF_REQ

7. Sends QGC_EOF_RESP

8. Close shared Memory handle

### QueryGrid Link

The main purpose of the QueryGrid Link subsystem in the QueryGrid architecture is to abstract all cross-cuttings concerns such as transport, security and routing into one single service, developed once and leveraged by all systems initiating or participating in QueryGrid queries.

Transport supports a streaming protocol for making metadata, import and export data request. It is responsible for establishing and managing TCP/IP based connections between QGL nodes, maintains a socket connection pool to cut done latency time and avoid socket exhaustions. Transport optionally supports over the wire compression on actual data blocks, and provides diagnostic check features to check network connectivity between QGLs in a given network fabric.

Security authenticates every connection received from either QGL, QGC and QGM. Optionally supports encryption over the wire.

Routing uses a default routing algorithm (1-N) to avoid data skew, supports bridge architecture to reroute data where direct connectivity isn't possible between local and remote QGL. Also, in future, intelligent routing techniques will be used to avoid redistribution on the data receiving end.

Query Level Instrumentation captures query level stats such as session, query phase, transfer rate and system resource usage, and reports query level status to QGM as part of periodic heart beat messages.

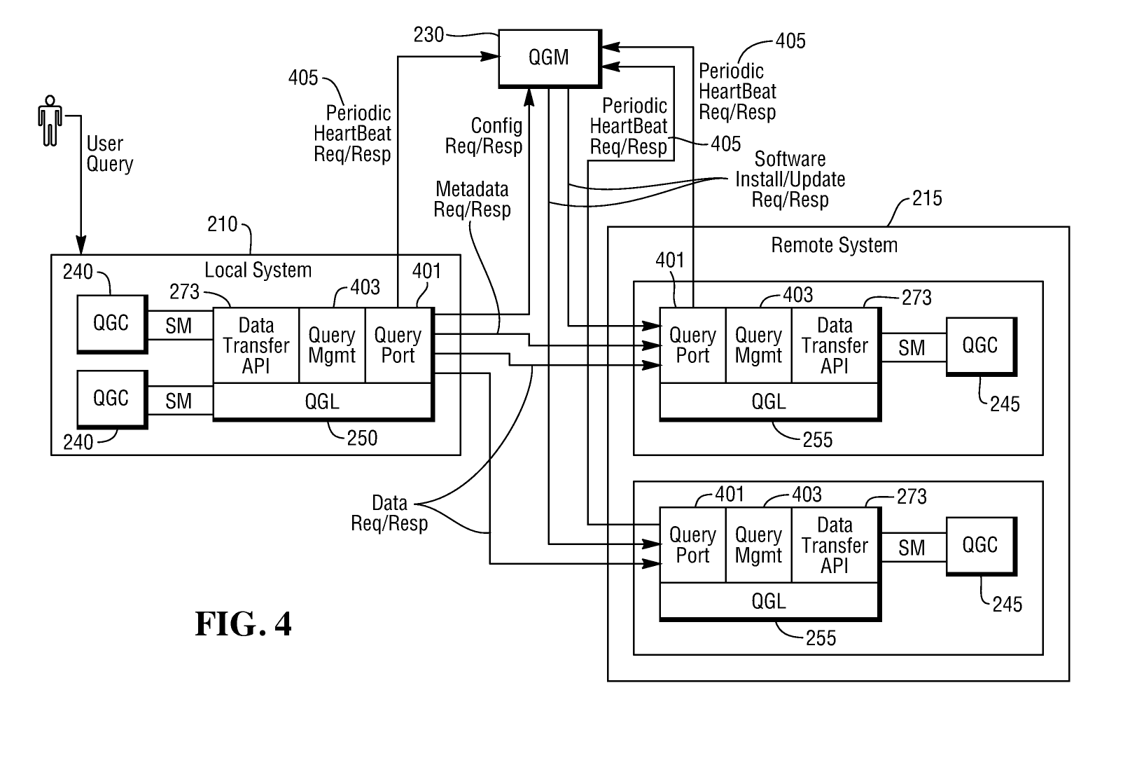

QueryGrid Link (QGL) is a software subsystem of QueryGrid which is a C++ based daemon service that runs on every node on both local and remote systems. QGL is monitored and managed by QueryGrid Manager (QGM) service. It is platform and content agnostic, completely decoupled from local platform, meaning it is not dependent on any specific release of the local platform, for example moving data from Teradata to Presto doesn't depend on a specific Teradata or Presto release. Any changes to subsystem can be released asynchronously and installed seamlessly without bringing down the local system. As illustrated in FIG. 4, QGL 250 responsibilities include:
Managing initial registration with QGM 230.
Maintaining up-to-date QueryGrid configuration details such as systems, connectors and communication policies which are used at query time to establish connections with remote QGLs 255 to send and receive data.
Managing a Queryport 401 to receive requests from local QueryGrid Connectors (QGC) 240 and remote QueryGrid Links 255. Plus, pull or push messages to QueryGrid Manager 230 using REST APIs.
Managing a Data Transport Layer 273 to efficiently transfer data over network to remote QGL(s) 255.
Maintaining a Query Manager 403 that understands requests from local QGCs 240 and remote QGLs 255, and builds a query execution model to process the request.
Maintaining a Resource Manager to execute query tasks in parallel.
Collecting real-time query and resource stats that can be sent to QGM 230 as part of regular heartbeat messages 405.
Sending heartbeat messages 405 to QGM 230 in a periodic fashion. Heartbeat message contains information regarding its health, query level instrumentation and overall resource usage.

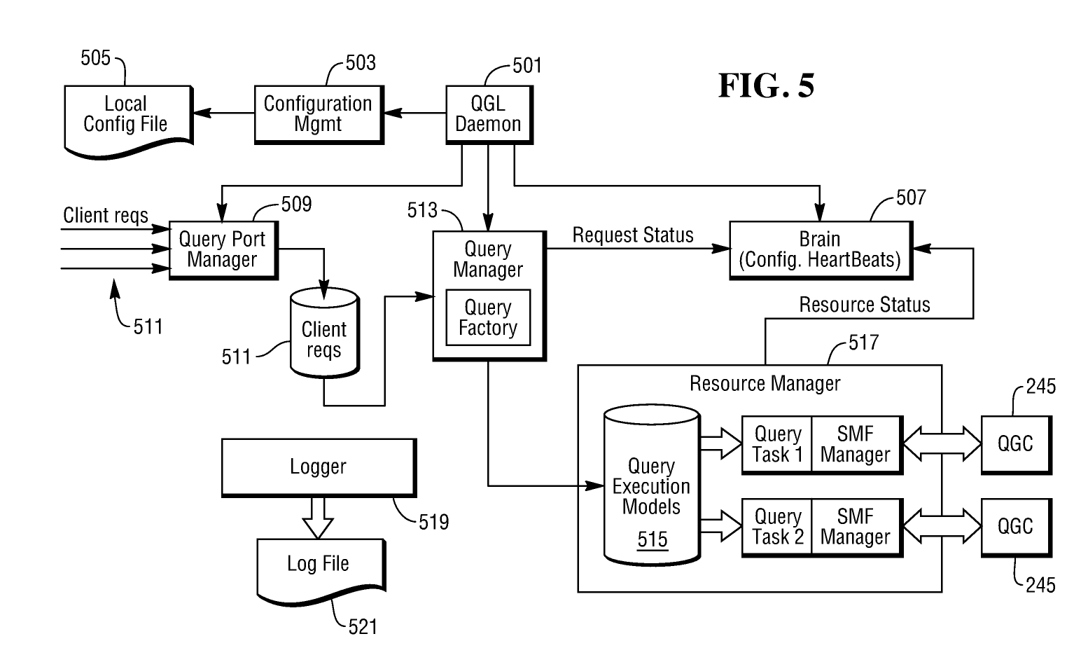

QGL comprises various core modules responsible for receiving request and data messages from initiator QGC 240 and routing them to appropriate target QGCs 245 in an efficient and secure manner Referring to FIG. 5, QGL modules include:
Daemon thread 501: responsible for bringing up the core manager components at startup based on configuration properties read from a local file and command line. Instantiates process level configuration and logger module instances.
Configuration Model 503: responsible for populating configuration (key, value) entries from a configuration file 505 and commandline, the values read from commandline overrides the values read from QGM. The configure module exposes getter and setter interfaces to read and write/update configuration entries at runtime.
Brain 505: responsible for sending heatbeats to QGM, keep Querygrid configuration up-to-date, and collecting query and resource level stats.
QueryPort Manager 507: responsible for maintaining a listen port and accepting requests 511 from QGC and QGM.
Data Transport Layer: A message subsystem uses to move data between QGLs in a secure and efficient manner
Query Manager 513: responsible for understanding requests 511, building query execution model 515 and managing the query execution.
Resource Manager 517: maintains Taskpools that provide an infrastructure to execute QGC/QGL requests in a parallel fashion.
Logger 519: is designed to log messages 521 from any QGL sub component.

The QGL resides on every node of a system and provides a means to the QueryGrid connectors to reach out to different remote systems in parallel to execute, process and transport data in an efficient manner QGL is payload agnostic during data transport, meaning it doesn't look into the data that is pertaining to QGC. It is responsible for sending regular heartbeats in a specific message format to QGM but it is not responsible for interpreting or rendering the data for the end-user. A QGL instance can behave like an initiator (querypoint) or responder or bridge process based on the request received from QGC/QGL. In the Teradata Unified Data Architecture (UDA), a user could define multiple QGNG fabrics, each fabric encompasses a set of systems, a system comprises of set of nodes, each node in a system can have one or more QGL instances, and each QGL instance is associated with a specific fabric name. In a given fabric, all QGL instances will be of same version. A unique query ID is associated with each data movement processed through QGL subsystem. The query information received from source and target connectors are propagated to QGM along with unique query ID which can be used to monitor the progress of a single data movement query that involves multiple systems.

The architecture supports systems of any size and can facilitate data movement between systems with different dimensions. It has no restriction on the size of data movement, can support tiny ones with fewer rows and large ones with billions of rows. The architecture provides the capability to QueryGrid Connector to involve all or fewer nodes in a QueryGrid fabric to accomplish the data movement. The design supports data movement through a push or pull model. Push model is used when the target system supports processing and pushing data in parallel, such as on Teradata, Aster and Hive systems. Pull model is used when the target system doesn't have the processing capability or the ability to push data in parallel to QueryGrid, e.g., HDFS.

The subsystem must exist on every node where QueryGrid Connectors can potentially run. So, to guarantee the high availability of the subsystem, a watchdog process is included in the architecture. Partial data transfer is not supported, so any failure during middle of a transfer is considered as failure and data movement is stopped. In this design, if the whole node goes down during middle of a data transfer then that query will fail but the following QueryGrid queries will continue to work as long as the local platform can operate on node failure.

All interactions between QGC and QGL is supported through a Linux domain socket and shared memory based IPC mechanism. All interactions between QGL to QGL is supported through TCP/IP based IPC mechanism.

The QGL brain is the most essential component of QGL. It is responsible for keeping QGL as an integral part of a QueryGrid system. Brain needs to be active in order for QGL to be part of a fabric.

Configuration management, as part of startup, downloads the complete configuration information from QGM via QueryPort Manager and caches the information for future use. Configuration management overrides default internal QGL configuration entries with the downloaded entries, and at regular intervals, checks for any configuration changes and updates the local cache entries as necessary.

Heartbeat messages are periodically sent to QGM to indicate the liveliness of QGL. The heartbeat can contain information such as resource usage at process level, query level instrumentation and health status such as task usage count, shared memory file usage and TCP/IP failure rates.

Stats collection exposes a set of callback interfaces to log query, resource and health statistics that can be summarized and pushed to QGM as part of periodic heartbeat messages. Query manager is designed to use these callbacks to send query level information such as sessionInfo, query phase and text. Resource manager is designed to use these callbacks to send query task level CPU resource usage such as CPU execution, iowait and elapsed time.

The Queryport Manager implements separate query ports for communicating with local QGCs and remote QGLs. It is lightweight, accepts client connections from QGC and QGLs, deserializes the messages, validates protocol version and constructs request models and add them to appropriate client queues. The client connections are later consumed by Query Manager and processed based on policy and local resource availability. It maintains a simple producer/consumer queue to accept messages as soon as they arrive in.

The Queryport Manager also manages a QGM port to make restful connections to registered QGM servers to periodically pull grid level configuration details such as systems, networks, fabrics, connectors and policies. The information retrieved is cached and used by query manager while processing requests from local QGCs. QGM port is also designed to send periodic QGL heartbeat messages to QGM.

QGM Queryport establishes a secure HTTP connection to one or more available QGMs and make periodic restful calls to pull grid level configuration details such as systems, networks, fabrics, connectors and policies. The configuration information retrieved is cached and eventually used by query manager module to process requests received from local QGCs. Brain uses QGM queryport to push periodic heartbeat messages to QGM.

QGC Queryport handles communication between local QGC and QGL through a Data Transfer API (DTA). The communication establishment is always from QGC to QGL. QGL is responsible for creating the communication channel(s) and the QGCs connect to them.

QGC Queryport is responsible for accepting connections from QGC and creating a shared memory channel for further QGC interaction on the user query. It creates a Linux domain socket in a well-known location for QGC to initiate the data movement. For a given QueryGrid query, multiple initiator QGCs can be invoked and expected to communicate with a single local QGL. Upon accepting individual QGC connections, a dedicated shared memory channel is created for further interaction with QGC to process the request such as metadata, data execute, import and export.

For interactions with QGC, QGC Queryport uses a set of well-defined message protocols that is provided by the Data Transfer API (DTA).

QGL Queryport listens on a TCP/IP port and accepts request from remote QGLs. A TCP/IP based Data Transport Layer is used to communicate between QGLs in a most efficient and secure way. The transport system is defined with a set of known messages to service different requests such as authentication, metadata, data and abort.

The Query Manager is designed to accept and process queries received from local QGCs 240 and remote QGLs 255. It is operated in a high priority environment. The Query Manager module's main responsibilities include:
1. Continuously pool Queryport manager for any new client requests.
2. Identifying the client request type and building a request model using a query factory.
3. Building one or more query execution task models based on query concurrency settings to service the request.
4. Adding execution tasks to resource manager queue so that each task can be executed in separate threads.
5. Cleanup query resources when a query is finished or aborted.

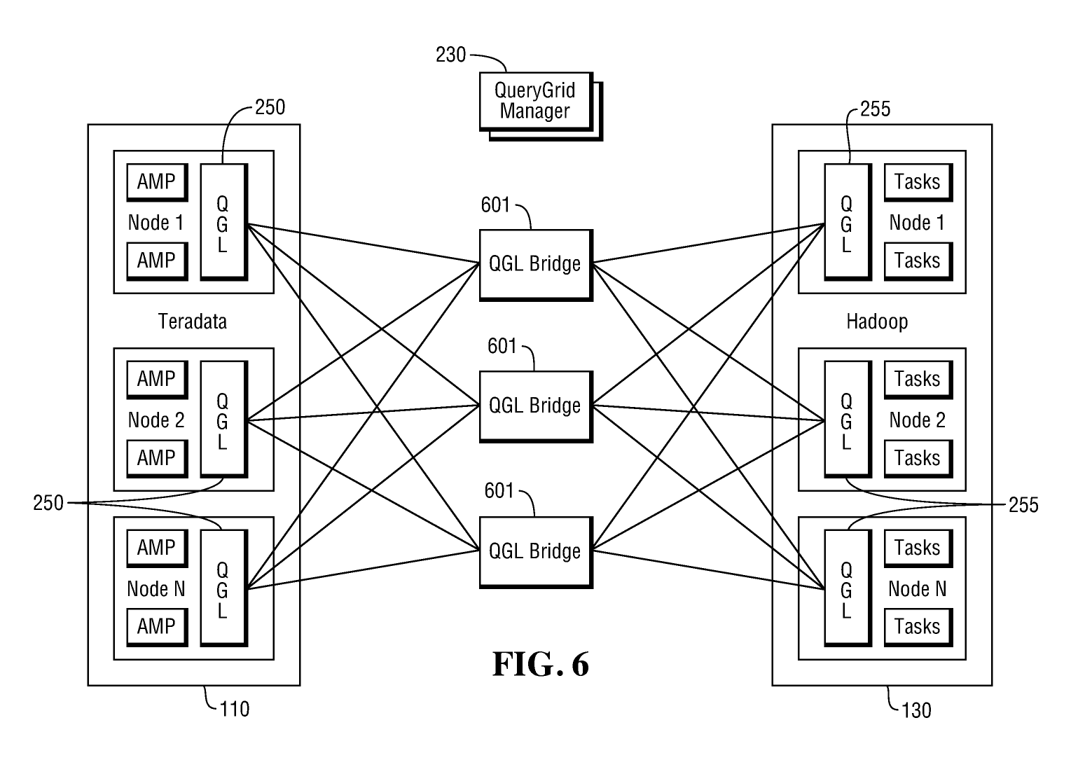

In order to process a QueryGrid query, an SQL engine on the local platform has to invoke a QueryGrid Connector (QGC) at different phases to process the information, as shown in FIG. 6. The connector that is invoked will establish a connection with local QGL to process the request on remote.

For a data movement query, QGC to QGL interaction can be categorized into three phases:
1. Metadata Retrieval—retrieve metadata from remote system.
2. Remote Query Execution—execute remote query to kick-off an import or export operation.
3. Data Retrieval—transport processed data (import/export operation)

As part of initial QGC to QGL handshake, a Universal Unique Identifier (UUID) is generated by the local QGL and shared with QGC. Both QGC and QGL will use this UUID in all messages used during these three phases.

The Metadata Retrieval phase is typically used for metadata queries such as help, explain, validate target system, retrieve remote table definition, and also for statistics collection and DDL/DML remote query execution queries.

A QGC on the querypoint side establishes a connection with local QGL. QGC sets session info, query info, payload and a coupling name with coupling version in shared memory before making a metadata request. Queryport Manager builds a metadata request model with the shared memory channel Query Manager consumes the metadata request model and constructs an execution model and adds it to resource manager pool to execute the model. As part of task execution, the Metadata Retrieval:
Resolves the IP address of the target QGL using the associated coupling properties downloaded from QGM.
Reads session and query information (local query ID, query text and query phase) from shared memory and logged to Brain. This information is eventually propagated to QGM as part of heartbeat.
Establishes a connection to remote QGL Queryport using Data Transport Layer and forwards the metadata request and waits for the response.

Remote Query Manager receives the metadata request, builds an execution model and adds it to resource manager pool to execute the model. As part of task execution, Metadata Retrieval:
Uses a coupling name sent from local QGC to determine the correct target drive-QGC to contact and the appropriate connector configuration to use.
Establishes a shared memory with and submits metadata request and target connector configuration ID.
Receives metadata response from driver-QGC and forwards it to querypoint side QGL. Closes established shared memory channel with driver-QGC. Driver-QGC: it is a process that runs on a target node which is responsible for submitting the actual SQL query to the local query engine.

Metadata response received from driver-QGC contains remote query information, e.g., remote query ID, remote session and remote query text. This information is logged to the brain and eventually propagated to QGM as part of heartbeat. When the execution task finishes, Query Manager cleans up the task resources.

The waiting Initiator QGL task receives the metadata response from remote QGL and passes the information on to local QGC via previously established shared memory channels.

The Remote Query Execution phase is used to submit a query on the target system to initiate an export or import operation. The query execution flow is very similar to Metadata Retrieval with few exceptions.
1. The data passed to remote drive-QGC will contain IP addresses of the nodes participating from querypoint.
2. Executes final commit to free up resources on participating QGLs.

During data processing phase, i.e., AMP phase, one of the QGCs is selected as a coordinator which is responsible for executing a parallel remote query. The coordinator QGC makes a data execute request to local QGL and pass on the coupling name and a hostname list (hostnames of the local nodes that are participating in the request). Local QGL resolves the following information based on coupling configuration and system configuration downloaded from QGM:
Resolves the target QGL IP address.
Resolves each hostname in host list to a network IP address available on that node.

Later, the coordinator QGL makes a data execute request to remote QGL with the resolved host list and waits for the response.

Upon receiving the request, remote QGL contacts the local driver-QGC to execute the remote parallel query on target platform, drive-QGC responds when the remote query is finished. Before forwarding the drive-QGC response to local QGL, it sends a commit message with UUID to all peer QGLs for resource cleanup. Local QGL receives data execute response and forwards it to QGC, then sends a commit message with UUID to all QGLs on the local system for resource cleanup.

The Data Retrieval phase is used to import or export data. Data-Retrieval phase is dependent on Remote-Query-Execution. Both Data-Retrieval and Remote-Query-Execution happens in parallel during mapper phase (AMP phase).

All mapper QGCs including the coordinator QGC participating in the query will establish a separate connection with local QGL with an import or export request. The Query Manager accepts QGC connections and add them to a lookup table based on their UUID and asynchronously waits for connections from remote end to occur.

The query executed on the remote through Remote-Query-Execution will bring up the mapper QGCs on remote nodes. The remote mapper QGCs establish connection with their local QGLs and submit an import or export request. As part of the request, it provides the initiator side host list provided to driver-QGC during data execute request in Remote-Query-Execution. The QGL accepts connections from QGCs and creates an execution model to move the data retrieved from QGCs to initiator side QGLs, and adds the execution model to its resource pool for execution. In the case of export, the data movement can be the other way, i.e., the data retrieved from initiator QGLs and sent to local QGCs. As part of task execution, Data Retrieval:
Establishes connections to all initiator QGLs present in host list. (1-N node mapping)
For import (SELECT),
   a. Reads a datablock at a time from QGCs in a round-robin fashion and pushes them to initiator QGLs in a round-robin fashion.
   b. Closes QGC connections as they reach end-of-file.
   c. Closes QGL connections when final commit is received from QGL that involved in executing the query.
For export (INSERT),
   a. Pulls a datablock at a time from initiator QGLs in a round-robin fashion and writes to QGCs in a round-robin fashion.
   b. Closes QGL connections as they reach end-of-file.
   c. Closes QGC connections when all QGL connections are closed and a final commit message is received from the local QGL that involved in executing the query.

On the initiator side, the initiator QGL that is waiting on data request receives connections form remote QGLs, builds an execution model with remote QGL connections and local QGC look up table, and adds it to its resource pool for execution. As part of task execution, Data Retrieval:

For import (SELECT),
a. Reads a datablock at a time from remote QGLs in a round-robin fashion and writes to QGCs in a round-robin fashion.
b. Closes QGL connections as they reach end-of-file.
c. Closes QGC connections when all QGL connections are closed and a final commit message is received from the local QGL that involved in executing the query on remote.

For export (INSERT),
a. Reads a datablock at a time from QGCs in a round-robin fashion and pushes them to remote QGLs in a round-robin fashion.
b. Closes QGC connections as they reach end-of-file.
c. Closes QGL connections when final commit is received from the local QGL that involved in executing the query on remote.

Every end user query is associated with a foreign object, e.g., Foreign server in Teradata. A foreign server object is created with a well-defined QGM named configuration object called ‘coupling’ that pairs a QueryPoint connector with a Target connector. During query execution time, the coupling name is passed on to the local QGL by QGC, The local QGL uses the corresponding QGM coupling configuration from its local cache, populated from QGM data. to perform the following functions:
1. During metadata or data execute phase, validate if the calling system name is listed as querypoint and permitted to initiate queries.
2. Determine which remote QGLs and driver node(s) to talk to, and the IP addresses of those nodes.

A system can have multiple network interfaces, but not all interfaces can be used for data movement. The QGM admin decides on the interfaces and the order in which they need to be used for data movement for a given fabric. During data execute phase, the brain QGC that is responsible for executing query on remote provides a hostname list to local QGL that contains local nodes that are participating in the request. QGL uses the network configuration information obtained from QGM for the local system and resolves each hostname in the list to a specific local network interface IP address. The list is passed on to remote QGC driver via QGL, and eventually to the mapper QGCs as part of remote query execution. The mapper QGCs pass on the host list to their local QGLs to establish connections with initiator QGLs to send/receive data.

The Initiator QGC may or may not know what user should be used for the remote system authentication. The QGM maintains a user mapping mechanism to facilitate this task. QGM maintains User Mapping and Credential Mapping entries to help map a local user to a remote user with respective credentials, and associate them with a coupling configuration.

At query time, the initiator QGC can provide local user name, remote user name, remote password and any other credentials needed for proper authentication at the remote site, if it has it, and this information is forwarded to remote QGL as-is, along with the coupling name. If coupling configuration contains a user mapping entry, then remote QGL will download that user mapping details and augment it with existing user credentials received from initiator QGC and pass on this information to driver QGC.

During import/export operation, not all individual QGLs participating in a request know when the actual query execution finishes, due to this nature they need to be informed so that they can do necessary clean ups and release resources that can be made available for processing future queries. In order to accomplish this, a commit message is supported for a QGL to inform its peers on query completion. This is mainly needed for queries that involves multiple local QGLs working in parallel.

The local and remote QGL involved in executing the remote query is treated as coordinating QGL, and made responsible for figuring out their peer nodes from system configuration data retrieved from QGM, and inform them when a response to remote query is received.

To support high query concurrency, the resource manager is designed to manage resources so that user queries can be executed in parallel. To execute queries asynchronously and minimize query starvation due to resource availability, two separate expandable task pools (metadata and data) are managed to promptly service metadata and data requests. Each taskpool can be configured separately. In a typical configuration, the metadata taskpool size is configured based on query concurrency limit, and data taskpool size is configured based on query concurrency limit and maximum mappers that can participate in a request. This configuration should make sure that the resource capacity of QGL provides adequate resources upfront for processing a parallel query. Once the concurrency limit is met, any queries submitted to QGL will be accepted and put into a pending client queue and executed when resources become available. The pending queue size can be configured to a larger number, once the queue becomes full then any connection received after that will be dropped.

Requests received from a client are converted to a task model before they get executed by a taskpool. The task models are created based on well define interface so that they can be managed efficiently managed by resource manager. Task model supports following functionalities:

TaskRun—To execute a query request model

TaskCanceled—Cancel task execution in case of an abort or runaway query.

TaskFailed—To inform failures during a task execution.

TaskCleanup—Used to clean up resources

A cleanup task is maintained separately to cleanup finished, canceled or failed tasks so that they can be used for future requests.

CPU and memory usage is calculated periodically from kernel data structures using proc filesystem calls and pushed to QGM as part of regular heartbeats. Also during query execution, CPU execution time is calculated and accumulated from individual query tasks.

There are three layers of authentication inherent to the QGL: QGL-to-QGM authentication. QGL-to-QGL authentication, and QGC-to-QGL authentication.

Unless the system is run in a completely unsecured setup, all three authentications are enabled and fully functional. A completely unsecured setup may be allowed for tightly controlled environments, in which case security in all of the QGLs participating in the QueryGrid is disabled.

In a secure or non-secure environment, QGL and QGM authentication happens through a HTTPS protocol, providing bidirectional encryption of communications between a client and server, which protects against eavesdropping and tampering with and/or forging the contents of the communication.

With QGL to QGL authentication, authentication messages are used to conduct an initial handshake between QGLs for any new or reestablished connections, so that both sides can verify each other's identity and establish a shared key used for secure integrity check and data encryption.

The mutual authentication is based on public key cryptography. In order to do verification successfully between QGLs, both sides need to have their own (public, private) key pairs, plus the other's public key information securely obtained via QGM. Each public key entry obtained from QGM will have a keyID, public key and encryption/checksum algorithm.

QGL-to-QGL authentication happens in two phases. In the first phase, the two sides negotiate the keyID to use. In the second phase, the two sides authenticate each other and establish the shared secret, using a Diffie-Hellman key establishment algorithm.

For QGL to QGC authentication, a mutual authentication at local system level is supported between local QGC and QGL. The authentication is based on Linux user ID that the processes run on, secured by UNIX domain sockets. As part of the initial handshake via Linux domain socket, authentication and authorization happens on both ends based on opposite parties Linux user ID and make decision to trust the connection.

Data Transfer API provides low level mechanics to efficiently manage and operate shared memory channels. The Data Transfer API also provides APIs in C++ and JAVA to exchanges messages between two processes via a shared memory channel, which are used for interactions between QGC and QGL.

A message passing subsystem is used to communicate between QGLs. The transport system is defined with a set of message types to effectively perform different user operations such as metadata, import, export and aborts. The layer exposes C++ based interfaces to serialize and deserialize each message structure to construct a request model. By default, it supports a basic data integrity check, and optionally it can support secured data integrity checks, data encryption and compression.

The data transport layer is designed to supported different level of integrity checks to protect data getting tampered over the wire. The integrity check is done on the message header and as well as on the data portion.

During import or export operations, data from a given node is sent to different target QGLs. As part of initiating an import/export request with local QGL, QGC passes the target QGL node list to contact. The local QGL can then use different node mapping algorithms to move data to target QGLs:

| | |
|---|---|
| 1 - N Mapping | Establishes a separate socket connection to all target |
| | QGLs in the host list provided by local QGC. |
| N - M Mapping | Establishes connection to target QGLs in a round-robin |
| | fashion. |
| | Example, data movement from a two node system (A) |
| | to 4 node system (B). |
| | A, node1 -> B, node 1 and node 3 |
| | A, node2 -> B, node 2 and node 4 |

Establishing new TCP/IP connections to remote systems for every query can become expensive and lead to socket exhaustion problems. To avoid such situations, a socket based connection pool is maintained by QGL so that successfully established connections can be reused for multiple queries. By default, the connection pool is enabled, and each connection added to connection pool is active forever until the connection becomes invalid.

Most QueryGrid configurations in a UDA platform environment will have direct network connectivity between systems, but there could be other cases where:

1. Data has to be moved across WANs.

2. No direct network connectivity available between systems.

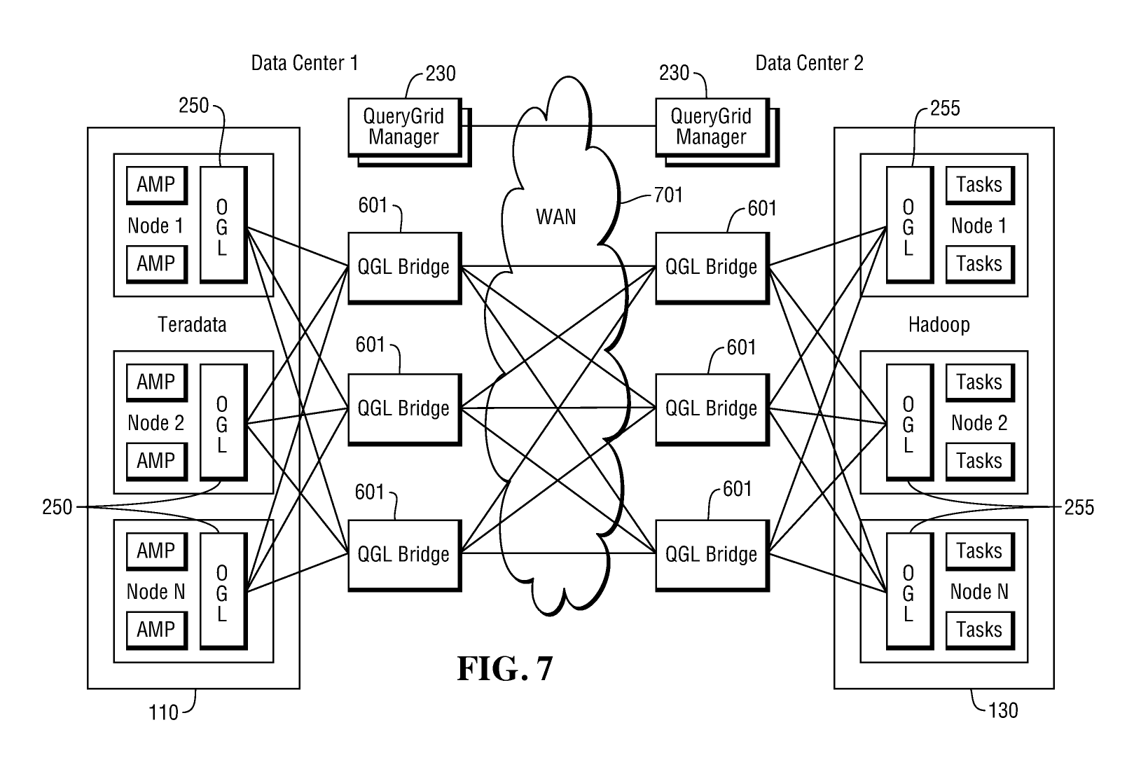

In these cases, the data transfer needs some special handling to effectively route data to target system via multiple network steps. In order to achieve this requirement, QGL operates as a bridging layer responsible for moving data from one QGL to another QGL. FIG. 6 provides an illustration of the use of OGL bridges 601 to connect a Teradata multi-node system 110 with a Hadoop multi-node system without direct network connectivity, or across a WAN 701, as shown in FIG. 7.

The logger includes an interface providing an option to specify log level, component name, query UUID and actual log message. By default, QGL sends all log messages to a local file. Optionally, it can be configured to push logs to QGM via a REST API. To support this functionality, a log buffer queue is managed and maintained by QGL, which accumulates log messages from different QGL components that can eventually be pushed to QGM as the queue fills up.

There can be scenarios where QGM may delay accepting log messages due to heavy volume of log messages or due to elastic search node failures. In those situations, the local log queue can possibly fill up and lead to log data loss. So, to avoid this situation, QGL consumes log entries in a log queue and writes them to a local file so that the new log messages can be added to log queue. Entries written to a local file will eventually pushed to QGM when QGM start accepting log messages.

The QGC to QGL message flow on initiator and target sides was discussed above under the heading QueryGrid Connector. Provided below is a description of the message flow between initiator and target QGLs for metadata, import and export phases.

Metadata Phase.

This is done during query parsing phase. The assumption is that only one QGC on the local side involved in this phase, and all available remote QGLs that can be involved to service the query are obtained from QGM. As far as QGL is concerned, the message sequence for metadata phase is same for both import and export operations.

Initiator side:
1. (QGL_AUTH_INIT_REQ) Connects to responder QGL and requests for initial authentication token information by passing the protocol version, clientId, pub/priv keyIds of initiator and responder.
2. (QGL_AUTH_INIT_RESP) Receives an auth confirmation response from responder QGL.
3. (QGL_META_REQ) Sends metadata request to responder QGL.
4. (QGL_META_RESP) Receives metadata response from responder QGL and closes the network connection to responder.

Responder side:
1. (QGL_AUTH_INIT_REQ) Receives authentication request from initiator QGL, validates protocol version, and the initiator identity.
2. (QGL_AUTH_INIT_RESP) Sends a auth confirmation response to initiator QGL.
3. (QGL_META_REQ) Receives metadata request from initiator QGL.
4. (QGL_META_RESP) Sends metadata response to initiator QGL.

Import Phase.

In this phase one or more initiator QGLs can be involved to receive data from multiple remote QGLs. Out of many initiator QGLs involved, only one acts like a brain and executes the actual query on a target QGL. Rest of the QGLs will act as simple workers and import data from remote QGLs.

Initiator side:
Remote query execution
   1. (QGL_AUTH_INIT_REQ) Connects to responder QGL and requests for initial Authentication token information by passing the protocol version, clientId, pub/priv keyIds of initiator and responder.
   2. (QGL_AUTH_INIT_RESP) Receives an auth confirmation response from responder QGL.
   3. (QGL_DATA_EXEC_REQ) Brain QGL sends a data execution request to responder QGL to execute the actual remote query via QGC driver process that starts the mappers for exporting data.
Importing data
   1. (QGL_AUTH_INIT_REQ) Receives authentication request from responder QGLs, validates protocol version, and the responder identity.
   2. (QGL_AUTH_INIT_RESP) Sends a auth confirmation response to responder QGLs.
   3. (QGL_EXPORT_REQ) Receives export request from multiple responder QGLs.
   4. (QGL_DATA_MSG) Receive one or more data messages from multiple responder QGLs.
   5. (QGL_EOF_MSG) Receive end-of-file message from multiple responder QGLs. End of file message contains total bytes sent from responder, validates this information with total bytes received count.
   6. (QGL_EOF_RESP) Sends end-of-file confirmation response to multiple responder QGLs.
Remote query execution
   1. (QGL_DATA_EXEC_RESP) Initiator brain QGL receives a data execution response from responder QGL who submitted the query on remote. Closes the socket connection established for the data execute request.
   2. (QGL_QRY_COMMIT_REQ) Sends an End of Request message to all initiator QGLs participating in the request. Upon receiving this message, QGL will clean up any resources used for the request.
   3. (QGL_QRY_COMMIT_RESP) Receives an End of Request confirmation message from all initiator QGLs participating in the request.

Responder side:
Remote query execution:
   1. (QGL_AUTH_INIT_REQ) Receives authentication request from initiator brain QGL, validates protocol version, and the initiator identity.
   2. (QGL_AUTH_INIT_RESP) Sends an auth confirmation response to initiator brain QGL.
   3. (QGL_DATA_EXEC_REQ) receives a data execute request from initiator brain QGL, invokes the appropriate QGC driver process to execute the remote query.
Exporting data:
   1. (QGL_AUTH_INIT_REQ) Connects to initiator QGLs and requests for initial Authentication token information by passing the protocol version, clientId, pub/priv keyIds of initiator and responder.
   2. (QGL_AUTH_INIT_RESP) Receives an auth confirmation response from initiator QGLs.
   3. (QGL_EXPORT_REQ) Sends export request to initiator QGLs.
   4. (QGL_DATA_MSG) Sends data messages to initiator QGLs in a round-robin fashion.
Remote query execution:
   1. (QGL_DATA_EXEC_RESP) Sends a data execution response to initiator brain QGL.
   2. (QGL_QRY_COMMIT_REQ) Sends an End of Request message to all responder QGLs participating in the request.
   3. (QGL_QRY_COMMIT_RESP) Receives an End of Request confirmation message from all responder QGLs participating in the request.
Exporting data:
   1. (QGL_QRY_COMMIT_REQ) receives End of Request message from QGL executing the remote request.
   2. (QGL_EOF_MSG) Sends end-of-file message to initiator QGLs. The message contains total byte count transmitted via the established connection.
   3. (QGL_EOF_RESP) Receives end-of-file confirmation from initiator QGLs. End of file response message contains total bytes received by the initiator, validates this information with total bytes sent count. On success, closes the socket connection. Otherwise sends a QGL ERROR MSG.
   4. (QGL_QRY_COMMIT_RESP) Sends an End of Request confirmation message to QGL executing the remote request.

Export Phase.

In this phase one or more initiator QGLs can be involved to receive data from multiple remote QGLs. Out of many initiator QGLs involved, only one acts like a brain and executes the actual query on a target QGL. Rest of the QGLs will act as simple workers and import data from remote QGLs.

Initiator side:
Remote query execution:
   1. (QGL_AUTH_INIT_REQ) Connects to responder QGL and requests for initial Authentication token information by passing the protocol version, clientId, pub/priv keyIds of initiator and responder.
   2. (QGL_AUTH_INIT_RESP) Receives an auth confirmation response from responder QGL.
   3. (QGL_DATA_EXEC_REQ) Brain QGL sends a data execution request to responder QGL to execute the actual remote query via QGC driver process that starts the mappers for importing data.
Exporting data:
   1. (QGL_AUTH_INIT_REQ) Receives authentication request from responder QGLs, validates protocol version, and the responder identity.
   2. (QGL_AUTH_INIT_RESP) Sends a auth confirmation response to responder QGLs.
   3. (QGL_IMPORT_REQ) Receives import request from multiple responder QGLs.
   4. (QGL_DATA_MSG) Sends data messages to multiple responder QGLs in a round-robin fashion.
Remote query completion:
   1. (QGL_DATA_EXEC_RESP) Initiator brain QGL receives a data execution response from responder QGL who submitted the query on remote. Closes the socket connection established for the data execute request.
   2. (QGL_QRY_COMMIT_REQ) Sends an End of Request message to all initiator QGLs participating in the request. Upon receiving this message, QGL will clean up any resources used for the request.
   3. (QGL_QRY_COMMIT_RESP) Receives an End of Request confirmation message from all initiator QGLs participating in the request.
Exporting data:
   1. (QGL_QRY_COMMIT_REQ) receives End of Request message from initiator brain QGL executing the remote request.
   2. (QGL_EOF_MSG) Sends end-of-file message to multiple responder QGLs. End of file message contains total bytes sent from initiator.
   3. (QGL_EOF_RESP) Receives end-of-file confirmation response from multiple responder QGLs. End of file response message contains total bytes received by the responder, validates this information with total bytes sent count.
   4. (QGL_QRY_COMMIT_RESP) Sends an End of Request confirmation message to initiator brain QGL.

Responder side:
Remote query initiation:
   1. (QGL_AUTH_INIT_REQ) Receives authentication request from initiator brain QGL, validates protocol version, and the initiator identity.
   2. (QGL_AUTH_INIT_RESP) Sends an auth confirmation response to initiator brain QGL.
   3. (QGL_DATA_EXEC_REQ) receives a data execute request from initiator brain QGL, invokes the appropriate QGC driver process to execute the remote query.
Importing data:
   1. (QGL_AUTH_INIT_REQ) Connects to initiator QGLs and requests for initial Authentication token information by passing the protocol version, clientId, pub/priv keyIds of initiator and responder.
   2. (QGL_AUTH_INIT_RESP) Receives an auth confirmation response from initiator QGLs.
   3. (QGL_IMPORT_REQ) Sends import request to initiator QGLs.
   4. (QGL_DATA_MSG) Receives data messages from initiator QGLs.
   5. (QGL_EOF_MSG) Receives end-of-file message from initiator QGLs. End of file response message contains total bytes transmitted by the initiator, validates this information with total bytes received count.
   6. (QGL_EOF_RESP) Sends end-of-file confirmation to initiator QGLs on success, and closes the socket connections to initiator QGLs. Otherwise sends a QGL ERROR MSG
Remote query completion:
   1. (QGL_DATA_EXEC_RESP) Sends a data execution response to initiator brain QGL.
   2. (QGL_QRY_COMMIT_REQ) Sends an End of Request message to all responder QGLs participating in the request.
   3. (QGL_QRY_COMMIT_RESP) Receives an End of Request confirmation message from all responder QGLs participating in the request.

The QueryGrid architecture described above and illustrated in the figures provides communication and access between multiple disparate data sources, such as Teradata Relational Database Systems, Teradata Aster Database Systems, Hadoop Distributed Storage Systems, and other systems within the Teradata Unified Data Architecture. The QueryGrid architecture includes connectors at data source nodes and links established between connectors to form a fabric, i.e., a set of interconnected nodes, which organizes QueryGrid components into a discrete environment and enables communication between paired data sources of the same or differing type within the environment.

The foregoing description of the invention has been presented for purposes of illustration and description. It is not intended to be exhaustive or to limit the invention to the precise form disclosed.

Additional alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A system comprising:
a plurality of disparate data sources;
a network connecting said disparate systems;
each one of said disparate data sources including at least one connector module specific to said one of said disparate data sources, said at least one connector module providing conversion of queries and data between said one of said disparate data sources and a different one of said disparate data sources; and
a link subsystem for establishing links, through said network, between connector modules associated with different ones of said disparate data sources links, thereby enabling the execution of queries and transmission of data between different ones of said disparate data sources.

2. The system in accordance with claim 1, wherein said disparate data sources include at least one of the following:
a relational database system;
an analytical database system;
a big data database system;
a multi-structured data database system;
a data lake;
a cloud-based data source; and
a hybrid-cloud data source.

3. The system in accordance with claim 1, wherein:
each link defines a communication pathway between a pair of connector modules.

4. The system in accordance with claim 1, wherein said disparate systems reside on separate networks; said system further comprising:
at least one bridge corresponding to each one of said networks for connecting said separate networks to a wide area network (WAN).

5. A system comprising:
a plurality of disparate data sources;
each one of said disparate data sources including at least one node connected to a network;
said at least one node within a first one of said disparate data sources including a connector module specific to said first one of said disparate data sources, said connector module specific to said first one of said disparate data sources enabling communication over said network between said at least one node within said first one of said disparate data sources and said at least one node within a second one of said disparate database systems; and
said at least one node within said second one of said disparate data sources including a connector module specific to said second one of said disparate data sources, said connector module specific to said second one of said disparate data sources enabling communication over said network between said at least one node within said second one of said disparate data sources and said at least one node within a first one of said disparate database systems.

6. The system in accordance with claim 5, further comprising:
a link subsystem for establishing a link defining a communication pathway between said connector module specific to said first one of said disparate data and said connector module specific to said second one of said disparate data pair of connector modules.

7. The system in accordance with claim 5, wherein said disparate data sources include at least one of the following:
a relational database system;
an analytical database system;
a big data database system;
a multi-structured data database system;
a data lake;
a cloud-based data source; and
a hybrid-cloud data source.

8. In an analytical environment including disparate data sources, a system for enabling the execution of queries and transmission of data between different ones of said disparate data sources, said system comprising:
within each one of said disparate data sources, at least one connector module specific to said one of said disparate data sources, said at least one connector module providing conversion of queries and data between said one of said disparate data sources and a different one of said disparate data sources; and
a link subsystem for establishing links, through said network, between connector modules associated with different ones of said disparate data sources links, thereby enabling the execution of queries and transmission of data between different ones of said disparate data sources.
